(19) United States
(12) Patent Application Publication
(10) Pub. No.: US 2015/0136158 A1
(43) Pub. Date: May 21, 2015

(54) SYSTEMS AND METHODS FOR A VAPORIZATION DEVICE AND PRODUCT USAGE CONTROL AND DOCUMENTATION

(71) Applicant: JJ 206, LLC., Seattle, WA (US)

(72) Inventors: Rick Stevens, Woodinville, WA (US); Brian Hewitt, Suquamish, WA (US); Trinitie Marie Vance, Tahuya, WA (US); Kathryn Mary Apsens, Silverdale, WA (US); Dan Preston, Bainbridge Island, WA (US); Joe Preston, Nordland, WA (US); Bob Barjesteh, Bainbridge Island, WA (US)

(73) Assignee: JJ 206, LLC, Seattle, WA (US)

(21) Appl. No.: 14/542,002

(22) Filed: Nov. 14, 2014

Related U.S. Application Data
(60) Provisional application No. 61/904,970, filed on Nov. 15, 2013.

(51) Int. Cl. A24F 47/00; H05B 1/02

(52) U.S. Cl. CPC A24F 47/008; H05B 1/0244
USPC 131/329

(57) ABSTRACT

Systems and methods are disclosed for managing and preventing liability issues relating to regulating usage and control of controlled substances. Systems include various means of administering controlled substances that are designed to prevent misuse and injury. Methods include various means of controlling dosage and preventing usage by minors or unapproved consumers. Methods include transparent labeling wherein all ingredients are clearly labeled and described as well as any potential health risks associated with use on the product packaging. Methods also include product marking tracing scenarios.

The present application claims priority to provisional patent application, U.S. Ser. No. 61/904,970, filed Nov. 15, 2013, Entitled UNIT AND METHODS FOR VAPORIZING CANNABIS OIL which is herein incorporated by reference in its entirety.

### TECHNICAL FIELD OF THE INVENTION

The present invention generally relates to an electronic unit for vaporizing oils for inhalation, and more specifically to an electronic, self-contained unit for vaporizing cannabis oil or other heavy oils for inhalation. Further the invention specifically relates to systems and methods for managing the “beginning to end” aspects of liability in the rapidly growing cannabis consumption industries, to include the liability associated with regulation, taxation, health and safety of controlled substances or substances benefiting from liability documentation. The key to these liability aspects are tenants of traceability, reporting, completeness, repeatability, security, and simplicity.

### BACKGROUND

### Tobacco History

Tobacco has been smoked in the Americas for centuries, beginning at least as far back as the Incan empire. Native Americans typically smoked tobacco for medicinal or spiritual purposes rather than recreational purposes. When Europeans began colonizing America in the early 1600s, tobacco was one of the first cash crops grown. By the early 1800s many Americans chewed or smoked tobacco recreationally on average 40 times per year. The first commercial cigarette was developed in 1865. Cigarette consumption in America peaked in the late 20^{th} century and has since been declining.

In the early 1950s, tobacco companies were using millions of dollars on ad campaigns specifically targeting different genders, ages, and ethnicities. Since at the time tobacco was a major source of revenue for the US government, the government chose to support the tobacco companies. By 1952, information began to become public linking cigarette smoke with cancer and consumption dropped for the first time in decades. By 1953 the tobacco companies were adding declarations to their ads such as “not injurious to health”, or claiming to be healthier than another brand (with no scientific support). Finally, in 1955 the Federal Trades Commission cracked down on advertising with claims having no basis in fact. From 1955 to the late 1990s tobacco companies continued to uphold that their products were not harmful while continuing to field law suits from individuals claiming they were misled. In 1998 the tobacco companies finally admitted to congress that smoking is addictive and may cause cancer.

Tobacco companies have spent billions in lawsuits over the years for reasons such as false and misleading advertising, marketing to underage individuals, racketeering, fraud, and negligent manufacture. Tobacco companies are still spending billions of dollars each year fighting liability based lawsuits resulting from decades of unrestricted marketing and sales, as well as false advertising and concealment of information regarding addiction, ingredients, and health risks.

When the first reports emerged linking cigarettes to cancer in the 1950s, smokers and their families began suing cigarette manufacturers. Plaintiffs in these early cases typically employed several legal theories in their lawsuits; primarily negligent manufacture, product liability, negligent advertising, fraud, and violation of state consumer protection statutes. In the 1980s, a new wave of lawsuits emerged. In the landmark case Cipollone v. Liggett, the plaintiff and her family alleged that cigarette manufacturers knew—but did not warn consumers—that smoking caused lung cancer and that cigarettes were addictive. Although Rose Cipollone's husband was awarded $400,000, an appellate court reversed the decision.

In the 1990s, plaintiffs began to have success in tobacco lawsuits. The first big win for plaintiffs in a tobacco lawsuit occurred in February 2000, when a California jury ordered Philip Morris to pay $51.5 million to a California smoker with inoperable lung cancer. Around this time, more than forty states sued the tobacco companies under state consumer protection and antitrust laws. These states argued that cigarettes contributed to health problems that triggered significant costs for public health systems. In November 1998, the attorneys general of 46 states and four of the largest tobacco companies agreed to settle the state cases.

In recent years, several key court decisions have paved the way for a raft of individual lawsuits against tobacco companies and have opened the door for class action lawsuits. In 2006, the Florida Supreme Court threw out a class action lawsuit brought on behalf of 700,000 smokers and their families against tobacco companies. In its ruling, the court found that tobacco companies knowingly sold dangerous products and kept smoking health risks concealed, but that the case could not proceed as a class action. Instead, the court ruled that each case must be proven individually. This ruling allowed for smokers and their families to bring individual lawsuits against the tobacco companies. In these lawsuits, plaintiffs need only prove that the individual plaintiff was harmed by an addiction to cigarettes. In the first of these cases to go to trial, the jury found that the death of a long-time smoker, Stuart Hess, was caused by his addiction to cigarettes.

### Cannabis History

Cannabis has a long history being used both for recreational and medical purposes. In 2900 BC it is noted that during the reign of Chinese Emperor Fu Hsi cannabis was used as a popular medicine. Usage of the substance can further be seen in different cultures through the ages. In 1213 BC records show cannabis being used in Egypt and in 200 BC the use of cannabis spread to Ancient Greece. Cannabis found its way to the Americas in the 15th and 16th centuries and continued to be used as a treatment for a broad range of ailments. Cannabis was soon listed in the US Pharmacopeia from 1850 to 1942 and was administered for various conditions including labor pains, depression, nausea, and rheumatism.

In the early 1900s, bolstered by prohibitionist sentiment, regulatory laws came into being addressing the use of cannabis. In 1911 Massachusetts became the first state to outlaw cannabis. The decades that followed were marred by regulations and the criminalization of cannabis. The Controlled Substances Act of 1970 classified cannabis along with heroin and LSD as a Schedule I drug, which meant that it was considered to have the comparatively highest abuse potential and thus medical use was no longer considered acceptable. Cannabis continued to be unarguably portrayed as a harmful substance until the many benefits of medical marijuana began to be recognized in the late 20th century.

There is a broad range of medical benefits attributed to marijuana. To date cannabinoids have been used to treat or aid in the treatment of innumerable conditions such as glaucoma, Dravet's Syndrome, anxiety, depression, Alzheimer's, pain, hepatitis C, Inflammatory Bowel Disease, Lupus, Crohn's disease, Parkinson's disease, PTSD, etc. These health benefits, although still being researched, are the basis for the marijuana legalization movement for both medical and recreational.

Proponents of the sale and use of medical and recreational marijuana have incited major changes in recent years. As of August 2014 there are twenty-three states and the District of Columbia that currently have laws legalizing marijuana in some form. Currently, Colorado and Washington State have laws legalizing marijuana for both medical and recreational use while the other twenty-one states permit only medical use.

As more US states are adopting less prohibitive marijuana laws, and some states are moving towards full legalization of marijuana, the marijuana industry is set to become a major economic competitor in the United States. Nearly 24 million Americans currently use or have recently used marijuana and usage is increasing steadily. As marijuana laws become less prohibitive it is likely more and more people will use marijuana on a regular basis either medicinally or recreationally, particularly as it becomes more culturally acceptable. It is anticipated that the marijuana industry could become as much, or more, pervasive than the alcohol industry.

Washington Initiative 502 (I-502) “on marijuana reform” was an initiative to the Washington State Legislature, which appeared on the November 2012 general ballot. It was approved by popular vote on November 6, and takes effect over the course of a year, beginning with certification no later than Dec. 6, 2012. Initiative 502 defines and legalizes small amounts of marijuana-related products for adults 21 and over, taxes them and designates the revenue for healthcare and substance-abuse prevention and education. Possession by anyone younger than 21, possession of larger amounts, and the growing of unlicensed or unregulated marijuana remains illegal under state law. As it is described by the Secretary of State's office, the measure shall “license and regulate marijuana production, distribution, and possession for persons over twenty-one; remove state-law criminal and civil penalties for activities that it authorizes; tax marijuana sales; and earmark marijuana-related revenues.”

### Administration

The two most common techniques for consuming cannabis leaves are by way of inhalation (i.e., via the lungs) or direct consumption (i.e., via the stomach). Inhalation is generally considered a more effective method with consumers since the effects of the inhaled cannabis may be felt in as little as seven seconds post-inhalation while still providing a means to control the dosage consumed. Reportedly, direct consumption of cannabis takes significantly longer to generate the same or similar effects—upwards of one to two hours post-consumption. Because of the time lapse of the effects during direct consumption, consumers may have a more difficult time properly controlling the dosage of the cannabis required.

The most common method of inhalation is by smoking: placing the cannabis plant material in a pipe or rolled in cigarette paper then igniting it with a flame and inhaling the resulting smoke. Combustion of cannabis plant material may produce smoke, odor, carbon monoxide and possibly carcinogens.

The most common techniques for using cannabis oil include oral ingestion and transdermal application. In the case of marijuana, the risk of respiratory effects from inhaling smoke is heightened by the more intensive way in which marijuana is smoked in comparison to tobacco. With smoking there is a prolonged and deeper inhalation, which, when paired with the use of an un-filtered marijuana cigarette, or “joint”, results in increased tar deposits in the lungs contributing to respiratory damage.

It is well know that carcinogens are detrimental to health. When a user inhales smoke via a cigarette, joint, etc. various respiratory problems can occur causing long term damage. As the inhaled smoke comes into contact with the airway and lungs it can cause visible and microscopic injuries. Frequent smokers can suffer from problems such as daily cough, increased phlegm production, wheezing, bronchitis, frequent acute chest illnesses, and heightened risk of lung infections. One major reason for these medical issues is the tar that is deposited in lungs when smoking most substances.

Vaporization is one method of consuming cannabis that limits the toxins entering the airways. The substance is heated to a temperature where cannabinoid vapors form, which is typically around 180-190 degrees Celsius. This is below the combustion temperature of about 230 degrees Celsius, which is the temperature where the noxious smoke and associated toxins are produced. Since vaporization allows the user to receive doses of cannabinoids while reducing the intake of carcinogenic smoke, it is considered to be one of the more preferred methods of cannabis administration.

There are other ways to administer marijuana to a user; however, each method comes with its own challenges. Due to the high combustion temperature of cannabis, smoking methods oftentimes employ water to cool down the smoke prior to inhalation. This decreases the risk of long-term damage to the esophagus, but still allows for tar deposits in the lungs and burning of the respiratory system. Other methods of consuming cannabis include smoking, edibles, topical, and tinctures.

One method of administering marijuana is to use an electronic cannabis cigarette adjusted to heat cannabis oil at a specific temperature. Compared to traditional cannabis cigarettes, electronic cannabis cigarettes are considered safer and healthier due to the reduction or non-presence of tar and carcinogens brought about by vaporization rather than burning. In regards to health, there are countless studies showing how smoking traditional tobacco cigarettes can put smokers at a higher risk of a host of conditions, including, but not limited to—stroke, heart attack, lung cancer, throat cancer, pneumonia, osteoporosis, Alzheimer's, and countless others. This is due to the fact that traditional tobacco cigarettes contain a myriad of chemicals many of which are carcinogenic.

Electronic nicotine cigarettes (e-cigarettes) were introduced into the American market in 2007. Since then the FDA has been battling with e-cigarette companies over regulation rights. Currently, e-cigarettes are going much the same legal route as their predecessors. For instance, e-cigarettes are currently not required to be labeled with the ingredients or a warning, e-cigarettes are widely used and marketed as being harmless but the effects of them have yet to be thoroughly researched, flavored and colored cartridges are being produced that are attractive to children, and people are e-smoking indoors. The World Health Organization has recently called for more regulation over e-cigarettes particularly to indoor use, false advertising, and marketing and sales to non-smokers and minors.

It is known that some consumers have tried to use conventional nicotine e-cigarettes, vape-pens and other oil-vaporizer devices (hereinafter generally referred to as “e-cigarettes”) to inhale the vapor from heated cannabis oil. However, one drawback of using a nicotine e-cigarette to inhale cannabis oil is that these e-cigarettes include a cotton-batting material to hold the low viscosity nicotine liquid. Without this batting in e-cigarettes the nicotine liquid leaks out.

Cannabis oil is more viscous than nicotine liquid. The more viscous cannabis oil clogs up the cotton-batting material of a nicotine e-cigarette and prevents the cannabis oil from flowing to the heating elements, which greatly restricts or prevents inhalation. Hence, conventional nicotine e-cigarettes are unfit for cannabis oil. Further, conventional vape-pens and other oil-vaporizer devices may require continuous upkeep, limit portability, and lack discreetness while being relatively expensive.

Thus far the inventors have addressed the history of smoking, its technology, the evolution of the industry following marijuana legalization as well as the evolving landscapes of litigation, politics and taxes. It is inevitable, cannabis is here to stay, the technical and socioeconomic challenges are being addressed and solved in a responsible way; the states of Washington and Colorado are leading the way. As one looks broadly now at this evolving ecosystem, while being mindful of lessons learned from the long fought litigation of the tobacco industry, considerations for liability and risk reduction will be key for this new cannabis industry. What the applicants believe is there are a number of administrative controls being adopted to cover such issues for liability, tax accountability and product certification. In addition to these higher level requirements, underlying them are key terms like traceability, repeatability, reporting, certification, and information accuracy assurance, especially in the areas of security, non-repudiation and authentication.

What is needed in the art are systems and methods for regulating usage and dosage of controlled substances so as to reduce potential liability issues. There are currently no all-inclusive liability management systems and methods in the art at this time. It is important to have a single set of systems and methods by which controlled substances are regulated so as to hold all manufacturers and distributors of controlled substances to the same set of standards.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### DESCRIPTION OF RELATED ART

In a discussion of prior art, the descriptions of the art are taken verbatim from the abstracts of the respective art. Typographical and syntax errors are left intact as they appear in the published documents.

U.S. patent Ser. No. 13/548,659 filed Jul. 13, 2012, titled ELECTRONIC CIGARETTE generally describes: [from the abstract] An electronic cigarette comprises nicotine without harmful tar. The cigarette includes a shell, a cell, nicotine solution, control circuit, and an electro-thermal vaporization nozzle installed in the air suction end of the shell. The advantages are smoking without tar, reducing the risk of cancer, the user still gets a smoking experience, the cigarette is not lit, and there is no fire danger. What this application does not disclose is a wicking feature drawing the oil through to the heating element, a disposable system, or a mechanically simple system, as well as a method for marking and tracing a cannabis concentrate product.

In a discussion of prior art, U.S. patent Ser. No. 14/244,376 filed Apr. 3, 2014, titled ELECTRONIC CIGARETTE generally describes: [from the abstract] An electronic cigarette includes a battery assembly and an atomizer assembly within a housing with the battery assembly electrically connected to the atomizer assembly. The housing has one or more air inlets. A liquid storage component is in contact with a porous component of the atomizer assembly, with the porous component having a run-through hole. A heating wire is in an air flow path through the run-through hole. What this application did not disclose is a system that is designed to vaporize various substances other than nicotine, a disposable system, or a wicking mechanism, as well as a method for marking and tracing a cannabis concentrate product.

In a discussion of prior art, WO patent Ser. No. CN2012/000,562 filed Apr. 26, 2012, titled ELECTRONIC CIGARETTE WITH SEALED CARTRIDGE generally describes: [from the abstract] An electronic cigarette comprises separate cartridge unit and vaporizer unit. The cartridge unit may have a cartridge tube containing a liquid with a seal sealing the liquid within the cartridge tube. The vaporizer unit may have a piercer and a heater, with the front side of the vaporizer unit moveable into engagement with the cartridge unit, causing the piercer to pierce the seal in preparation for use of the electronic cigarette. A battery may be connected to a back side of the vaporizer unit. The vaporizer unit may also have an electronic circuit electrically connected to the heater and to an inhalation sensor. What this application did not disclose is cartridge filler that is not a nicotine solution or a cotton-free oil distribution system, as well as a method for marking and tracing a cannabis concentrate product.

In a discussion of prior art, WO patent Ser. No. CA2012/000,767 filed Aug. 13, 2012, titled PORTABLE ELECTRONIC VAPOR-PRODUCING DEVICE AND METHOD generally describes: [from the abstract] The present invention is a portable electronic vapor-producing device which converts chemical substances in liquid form to a gaseous form so that active ingredient(s) can be inhaled by the user for therapeutic or medicinal purposes. The device includes: a power module: a primary module: and an auxiliary module that may be enclosed separately in exterior hollow casings and fitted together, or enclosed together in one single exterior hollow casing. The primary module includes: an anode assembly: a cask assembly: and a heater assembly. The anode assembly includes an anode barrel, which is hollow, fixed permanently in place and contacts the batten: a cathode mount, which is fixed permanently in place and contacts the heater assembly: and an anode mount, which moves between contacting the anode and not contacting the cathode in response to a vacuum produced by user inhalation. What this application did not disclose is a circuit connection that is made employing the conductivity of the fluid used in the device, a disposable device, or use of non-liquid substances, as well as a method for marking and tracing a cannabis concentrate product.

In a discussion of prior art, U.S. patent Ser. No. 13/939,987 filed Jul. 11, 2013 titled HOT-WIRE CONTROL FOR AN ELECTRONIC CIGARETTE generally describes: [from the abstract] An electronic cigarette (“e-Cig”) may include functionality for monitoring and controlling the thermal properties of the e-Cig. The system and method described herein may monitor a temperature based on a resistor (i.e. hot wire) near the wick and model the thermal cycle of an e-Cig. The model can be used for controlling the temperature of the e-Cig and preventing burning. The temperature control may dictate optimal conditions for atomization and smoke generation in an e-Cig while avoiding hotspots and burning to the atomizer or cartomizer. What this application did not disclose is a single use device or use of non-liquid substances, as well as a method for marking and tracing a cannabis concentrate product.

In a discussion of prior art, U.S. patent Ser. No. 13/741,217 filed Jan. 14, 2013 titled ELECTRONIC CIGARETTE generally describes: [from the abstract] An electronic cigarette includes a liquid supply including liquid material, a heater operable to heat the liquid material to a temperature sufficient to vaporize the liquid material and form an aerosol, a wick in communication with the liquid material and in communication with the heater such that the wick delivers the liquid material to the heater, at least one air inlet operable to deliver air to a central air passage upstream of the heater, and a mouth end insert having at least two diverging outlets. The electronic cigarette can also include an air flow diverter which directs incoming air away from a heating zone of the heater. What this application did not disclose is a single simplified cylinder to contain the components of the electronic cigarette, use of non-liquid substances, and a cotton-free liquid container, as well as a method for marking and tracing a cannabis concentrate product.

In a discussion of prior art, U.S. patent Ser. No. 13/157,024 filed Jun. 28, 2011 titled ELECTRONIC CIGARETTE WITH LIQUID RESERVOIR generally describes: [from the abstract] An electronic cigarette including an elongated housing that has a mouthpiece with an aerosol outlet, and an atomizer disposed within an atomizing chamber. The atomizer selectively generates an aerosol of the liquid in response to suction pressure at the aerosol outlet. The atomizing chamber has an air inlet, an atomizer outlet coupled to the aerosol outlet, and a first wick aperture. A liquid reservoir is disposed within the elongated housing, which is sealably separated from the atomizing chamber. A wick disposed through the first wick aperture between the liquid reservoir and the atomizing chamber and it is configured to transfer the liquid by capillarity from the liquid reservoir to the atomizer. What this application did not disclose is a wick housed completely within the atomizing chamber, communication with smart devices, and a cotton free substance container, as well as a method for marking and tracing a cannabis concentrate product.

In a discussion of prior art, U.S. patent Ser. No. 13/870,654 filed Apr. 25, 2013, titled ELECTRONIC CIGARETTE WITH COMMUNICATION ENHANCEMENTS generally describes: [from the abstract] An electronic cigarette (“e-Cig”) may include a controller for providing various operations within an e-Cig. Enhancements for the controller may provide for improved operations and control for the e-Cig. In one embodiment, there may be a communications capability that may allow for the e-Cig to communicate with a consumer device. The consumer may then control smoke properties, monitor operations, adjust settings, and/or receive product notifications or offers through the consumer device's communication with the e-Cig. The communications may enable connections to various websites on the Internet for usage tracking or social networking. What this application did not disclose is the method of tracing the substances and preventing misuses of the device, as well as a method for marking and tracing a cannabis concentrate product.

In a discussion of prior art, U.S. patent Ser. No. 14/138,202 filed Dec. 23, 2013, titled SMART ELECTRONIC CIGARETTE generally describes: [from the abstract] An electronic cigarette includes a memory, a processor communicatively coupled to the memory and configured to run an electronic cigarette application stored in the memory, and an output circuit that transfers information from the electronic cigarette application to a remote electronic cigarette application separate from the electronic cigarette. An indicator such as an audible indicator and/or a visual indicator provides information, such as an indication that the electronic cigarette needs recharging or an indication to a user implementing a smoking cessation program. The remote electronic cigarette application can be a remote server-based application, a remote cloud-based application, and/or a mobile-device-based application. The remote electronic cigarette application shares transferred information with a social media account. An input circuit receives from the remote electronic cigarette application remote information and/or remote commands. What this application did not disclose is a user authentication process and ways to prevent device tampering, as well as a method for marking and tracing a cannabis concentrate product.

In a discussion of prior art, U.S. patent Ser. No. 13/949,988 filed Jul. 24, 2013, titled DIGITAL MARKETING APPLICATIONS FOR ELECTRONIC CIGARETTE USERS generally describes: [from the abstract] An electronic cigarette (“e-Cig”) may include functionality for targeted marketing. The marketing may be through communications with a computing device, such as a smartphone. For example, a smartphone application may be used for monitoring e-Cig usage and collecting data regarding the user and the usage. That data may result in targeted marketing. In another example, location information may also be used for targeted advertisements from a retailer. What this application did not disclose is a process to authenticate the user and control use and dosage, as well as a method for marking and tracing a cannabis concentrate product.

In a discussion of prior art, U.S. patent Ser. No. 10/593,323 filed Mar. 16, 2005, titled MOBILE TELEPHONE ALL IN ONE REMOTE KEY OR SOFTWARE REGULATING CARD FOR RADIO BICYCLE LOCKS, CARS, HOUSES, AND RFID TAGS, WITH AUTHORIZATION AND PAYMENT FUNCTION generally describes: [from the abstract] The “All In One Remote Keys” (AIORK) for (GSM, UMTS, W-LAN, Bluetooth, RFID-transceiver) mobile phones and/or extension kits is a universal key for all kind of locks, gates or entrances and it has a direct payment- and clearing function for electronic (Bluetooth, WLan, GSM and esp. NFC RFID-) cash payments for all consumed accesses, services or information. The input can be made by fingerprint or oral with direct biometric sensor confirmation. The NFC transceiver is for: Info-download, direct-cash-payment, access-control, function control, authentification of internet-auctions, -betting and -stock transactions and of such information and over all for RFID-tag identification of worthy objects, electronic devices and parts etc. with GSM based Internet website or account clearing. And it is running and lets manage a mobile-phone-platform with video-clip-hitcharts, which is with fingerprint-sensor authentication the best quality bringing solution for e.g. news etc. looking mobile video phone user/consumer and which is so finally the only functioning or establishing mobile video phone solution. What this application did not disclose is a method to regulate and prevent misuse of the unit, as well as a method for marking and tracing a cannabis concentrate product.

### SUMMARY OF THE INVENTION

Although the best understanding of the present invention will be had from a thorough reading of the specification and claims presented below, this summary is provided in order to acquaint the reader with some of the new and useful features of the present invention. Of course, this summary is not intended to be a complete litany of all of the features of the present invention, nor is it intended in any way to limit the breadth of the claims, which are presented at the end of the description of this application.

The present invention provides among other things systems and methods for the control and reporting for electronic vaporizers used for inhalation of cannabis concentrates, and more specifically for an electronic, self-contained unit for vaporizing cannabis oil or other heavy oils for inhalation and methods for managing the “beginning to end” aspects of control and reporting in the rapidly growing cannabis consumption industries, to include the liability associated with regulation, taxation, health and safety of formerly controlled substances. In the embodiments discussed herein, the term “beginning to end” refers to the beginning of the production and distribution of the cannabis product and cannabis administration device(s) to the end-use by the user. Key to these liability aspects are tenants of traceability, reliability, reporting, completeness, repeatability, security and simplicity.

Other features of the present invention will be apparent from the accompanying attachments and from the description that follows.

Aspects and applications of the invention presented here are described below in the drawings and description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶ 6. Thus, the use of the words “function,” “means” or “step” in the Detailed Description or Description of the Drawings or claims is not intended to somehow indicate a desire to invoke the special provisions of 35 U.S.C. §112, ¶ 6, to define the invention. To the contrary, if the provisions of 35 U.S.C. §112, ¶ 6 are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ”, if the claims also recite any structure, material or acts in support of that means or step, or that perform the recited function, then it is the clear intention of the inventors not to invoke the provisions of 35 U.S.C. §112, ¶ 6. Moreover, even if the provisions of 35 U.S.C. §112, ¶ 6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like-reference numbers refer to like-elements or acts throughout the figures. The presently preferred embodiments of the invention are illustrated in the accompanying drawings, in which:

FIG. 1 is a diagram depicting the components that comprise a generic vaporization unit.

FIG. 2A, 2B, 2C depict examples of different substance container shapes.

FIG. 3 depicts examples of filters and filter shapes that can be used.

FIG. 4 depicts a simplified side view of an embodiment of the vaporization unit.

FIG. 5 depicts an exploded side view of an embodiment of the vaporization unit.

FIG. 6 depicts an assembled top view of an embodiment of the vaporization unit.

FIG. 7 depicts an isometric view of an embodiment of the vaporization unit.

FIG. 8 depicts microcontroller architecture for a disposable embodiment.

FIG. 9 depicts microcontroller architecture for a reusable embodiment.

FIG. 10 depicts an extended architecture with respect to hardware and logic.

FIG. 11A, 11B, 11C depict a battery activation pull-tab, twist, and a crimping.

FIG. 12 depicts a USB implementation.

FIG. 13 depicts a wireless embodiment using protocols.

FIG. 14 depicts using an NFC transceiver for two-way (point-to-point) interactions.

FIGS. 15 through 17 depict schematics for the vaporization unit power supply.

FIG. 18 depicts public/private key usage.

FIG. 19 depicts communication between a filling machine and a vaporization unit.

FIG. 20 is a flow chart describing steps involved in filling a vaporization unit with substance.

FIG. 21 depicts a communication scheme between the vaporization unit, smart devices, application, and a server and/or cloud.

FIG. 22 depicts a flow chart describing steps that may occur when a vaporization unit is activated.

FIG. 23 is an extension of FIG. 22 depicting authentication of a vaporization unit using an application on a smart device.

FIG. 24 depicts the composition of a standard data packet.

FIG. 25 is a diagram depicting how a data packet is transferred.

FIG. 26 depicts possible usage control and regulation systems.

FIG. 27 depicts how a biological sample may be analyzed.

FIG. 28 depicts the process diagram for the winterization process.

FIG. 29 depicts a Soxhlet extractor.

FIG. 30 depicts the reclamation process for solid wastes.

FIG. 31 depicts the setup for the reclamation of liquid wastes.

FIG. 32 depicts the reclamation process for liquid wastes.

FIG. 33 depicts the process for cleaning the Soxhlet extractor.

FIG. 34 depicts the microcontroller for OTP temperature control

FIG. 35 depicts an example terpene analysis graph.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

In the following examples of the illustrated embodiments, references are made to the accompanying drawings which form a part hereof, and in which is shown by way of illustration various embodiments in which the invention may be practiced. It is to be understood that other embodiments may be utilized and structural and functional changes may be made without departing from the scope of the invention.

### Embodiment 1

### The Vaporization Unit

An embodiment of the vaporization unit 405 includes a self-contained disposable electronic-unit for vaporizing consumable products such as cannabis oil and other substances. The vaporization unit may take on the outward appearance similar to an e-cigarette and may be portable and concealable. The vaporization unit includes a cotton-free substance container, capped with a fiber wick/screen that allows the substance to flow to a vaporization chamber as needed.

One or more aspects of the vaporization unit 405 may advantageously allow consumers an easy, convenient, socially acceptable, affordable method of consuming cannabis, and other substances, while controlling the amount they use. The cannabis oil or other substance is vaporized to gain the medicinal benefits. The vaporization unit will allow consumers discrete access to the benefits of cannabis or other substances without having to deal with the actual plant, grinding, rolling, and smoking. And, vaporization eliminates the combustion of the plant material, which is the key source of carcinogens in smoking. Preferably, the vaporization unit does not produce any carbon monoxide, is odor-free or virtually odor-free, and does not produce second hand smoke.

### Overview

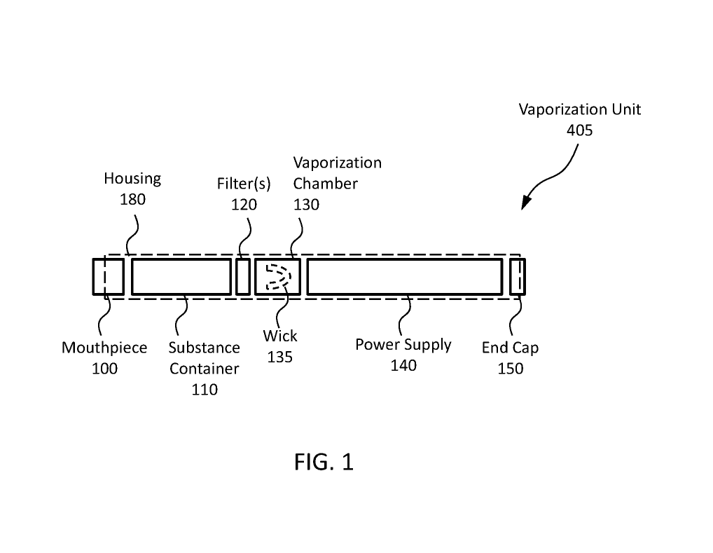

Referring to FIG. 1, generally each vaporization unit 405 will comprise a mouthpiece 100, a substance container 110, a filter or filters 120, a vaporization chamber 130 with a wick 135, a power supply 140, an end cap 150, and a housing 180. While each of the primary components are shown as separate entities in the figure, they may overlap, be attached, or combined or partially combined. The overall shape of the vaporization unit will generally be cylindrical, though other shapes are possible. One or more of the components may be enclosed or partially enclosed in the housing 180. The substance container 110 and other components of the vaporization unit may be sealed to prevent or minimize any leakage of substance.

### Housing

A housing 180 encloses or partially encloses one or more of the vaporization unit components. The housing 180 is preferably cylindrical in shape, but may take other forms. The housing is preferably heat-resistant. The vaporization unit may be self-contained requiring little to no assembly by a consumer.

### Mouthpiece

The mouthpiece 100 may be variable in size and shape provided it has an end shaped to mate with the first end of the vaporization unit. The mouthpiece 100 may be formed from a polymer material. The mouthpiece 100 may be coated, preferably with anti-microbial coating.

Interchangeable mouthpieces 100 of varying shape, color, and/or material may be used. Mouthpieces 100 may be made of, or coated with, anti-microbial materials.

### Substance Container

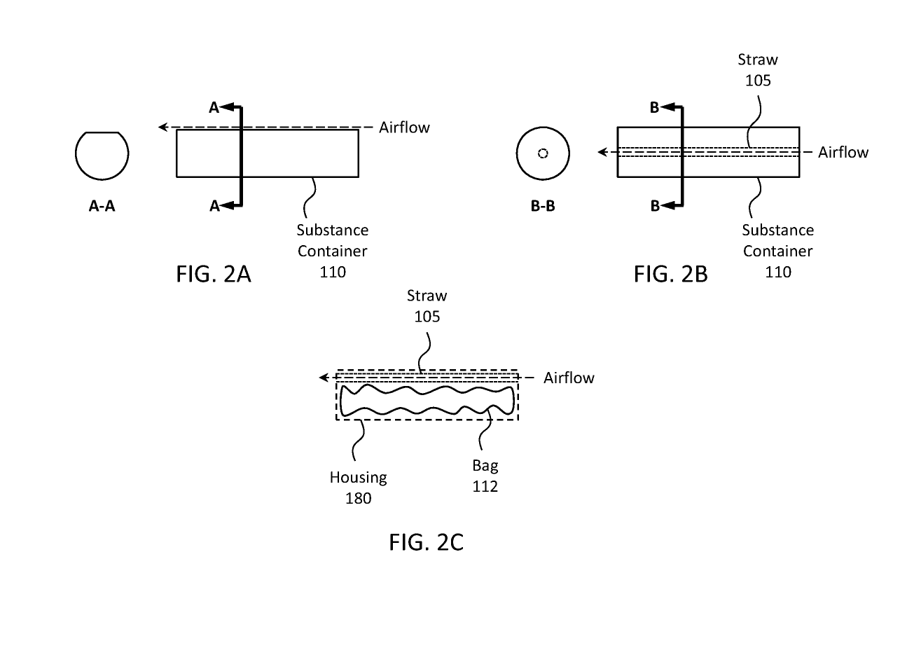

The substance container 110 may be generally a cylinder or a shape corresponding to the overall shape of the vaporization unit. The substance container 110 may also be shaped so as to allow airflow to travel between it and the housing 180 to the mouthpiece 100, as shown in FIG. 2A. Alternatively, the substance container 110 may be a bag, as shown in FIG. 2C. The substance container 110 of the preferred embodiment may or may not include any cotton or other absorbent material.

In an alternate embodiment, the substance container 110 is removable from the vaporization unit. In this embodiment with the removable substance container 110, the substance container 110 comprises its own communication tracking mechanism, such as Radio-Frequency Identification (RFID) tag, chip or Near Field Communications (NFC) tag or bar code.

Cotton is a fibrous organic compound that is often used as filters or wicks in conventional electronic nicotine cigarettes. However, as cotton is burned it releases carcinogens, which in turn are inhaled by the user along with an abundance of small cotton fibers. The carcinogens can contribute to user discomfort as well as being an agent directly involved in causing cancer. In addition to carcinogens, dry wicks and filters can produce cotton dust. If the user is exposed to cotton dust it can affect breathing, irritate the eyes, nose, and throat and can cause serious permanent lung damage (byssinosis). Even though most e-cigarettes employ cotton as a filter material vaporization unit 405 may circumvent the use of cotton, which in turn may protect the user from potential carcinogens, discomfort, irritation, and serious damage.

FIG. 2A depicts one embodiment of the substance container 110. The substance container 110 is generally a cylinder having two ends and a flat edge along its length. The flat edge allows the vaporized substance to flow past the container 110, between the container 110 and the housing 180, to the mouthpiece 100. The first end, situated closest to the mouthpiece 100, has an opening that may be filled with a silicon or rubber stopper through which the oil or liquid substance may be injected or to seal the container 110 after the substance has been placed. The second end is configured to distribute substance to the wick 135 for vaporization.

FIG. 2B depicts another embodiment of the substance container 110 wherein the substance container 110 is generally a cylinder. In this embodiment the vaporized substance flows through a straw 105 that may be along one edge of the container 110, along the centerline, or otherwise situated within the cylinder. The straw 105 may be flexible or inflexible. The substance may be pressed towards the vaporization chamber 130 as the unit is used by inducing pressure in the container 110 during filling. This will allow the vaporization unit to continuously draw the substance regardless of orientation. Alternatively, a plunger mechanism can be introduced in the substance container 110 to press the oil towards the vaporization chamber 130. The plunger will work in much the same manner as the induced pressure.

FIG. 2C depicts yet another embodiment of the substance container 110 wherein the substance container 110 is a bag 112. The bag 112 can be filled after insertion in the housing 180 and will take the shape of the housing 180 as it is filled. One benefit of a bag 112 is that as the substance is consumed, the bag 112 will be pulled towards the vaporization chamber 130 thus keeping the substance near the wicking area regardless of the orientation of the vaporization unit. Another benefit of the bag 112 is that it prevents the substance from sticking to the sides of the substance container 110, thus reducing waste.

The bag 112 may include one or more reed valves. There may be a reed valve on the first end, situated near the mouthpiece 100, to aid in filling of the bag 112. A needle or thin tube can be inserted in the valve for filling and the valve will prevent leakage after filling. There may be one or more reed valves at the second end of the bag 112, in proximity to the vaporization chamber, through which the wick 135 can be partially inserted.

Referring back to FIG. 1, partial insertion of the wick 135 in any embodiment of the substance container 110 allows for the wick 135 to only draw enough of the substance to keep it saturated and will prevent too much substance from entering the vaporization chamber and pooling. This allows for less substance to be wasted, and more efficient, higher quality vaporization. In some embodiments both ends of the wick 135 may be partially inserted into the substance container 110. In some embodiments there may be more than one wick 135.

### Filters

Still referring to FIG. 1, the filter or filters 120 allow for the transfer of substances while refraining from impeding the flow through the unit. The filter 120 prevents various particulate from passing. A filter 120 may be made of various substances such as polymers, fabric, paper, metal, ceramic, etc. The size and type of particulate being filtered can be controlled by considering the filter 120 material, porosity, and thickness. The filter 120 may be shaped to match the shape of the substance container 110 or the housing 180.

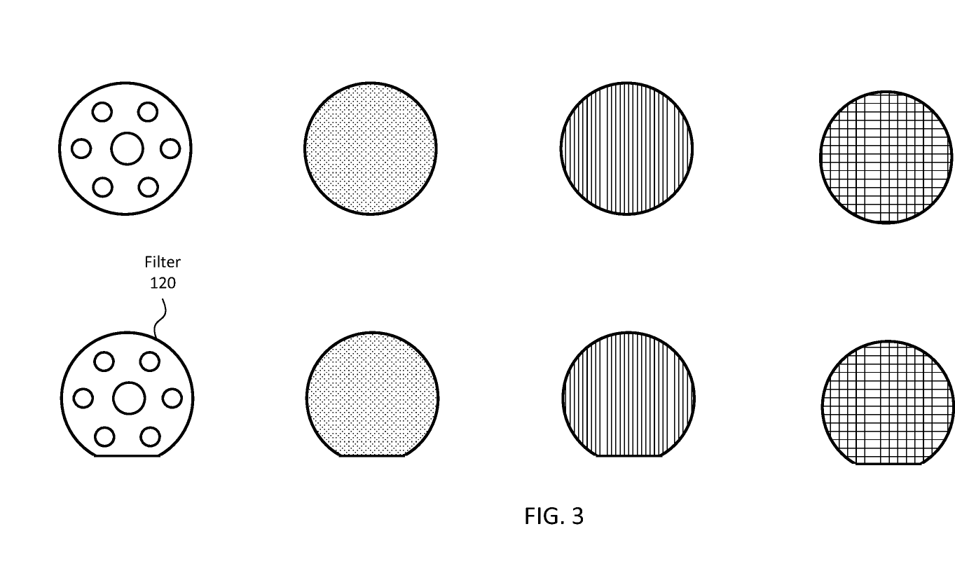

A filter may take forms such as a screen, wick, for instance. FIG. 3 depicts one or more of the filter options for the vaporization unit. A screen allows for the prevention of larger particulate to move through the system. The screen may be comprised of materials such as polymers, paper, fabric, metal meshing, and other organic compounds. A wicking material allows for substances to be wicked by the filter 120 to the vaporization chamber as well as cleared of unwanted particulates.

In addition, the filter 120 operates as a membrane-atomizer to control the flow of the substance. The filter 120 thus controls the vaporization and the dosage of substance available to the user for each inhalation. In one embodiment, the vaporized substance is received by the user at a constant rate or approximately constant rate via capillary action, controlled by the filter 120.

### Vaporization Chamber

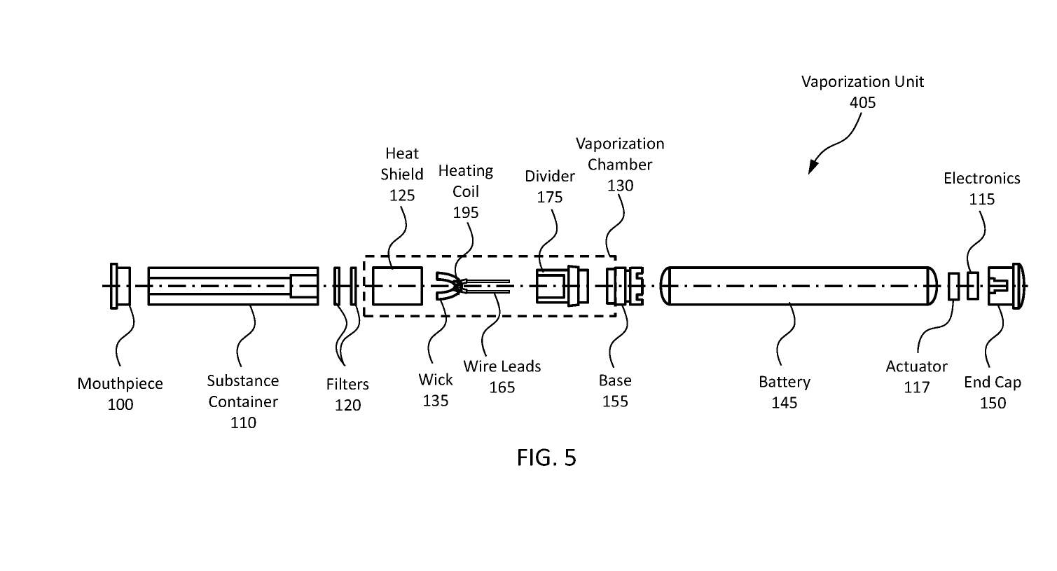

Referring back to FIG. 1, the vaporization chamber 130 will generally contain at least one wick 135. The chamber 130 will be encompassed by a heat shield (see FIG. 5) to protect the user from the high vaporization temperatures. Generally, the wick 135 may be composed of a fibrous material. The wick 135 may be wrapped with a conductive wire which causes the substance to vaporize as it is heated. The number of coils is dependent on the wick 135 material and the desired vaporization temperature. In some embodiments, the wick 135 may be ceramic.

In one embodiment the substance is held in the substance container 110 and flows via capillary action through filter 120 as it is vaporized.

In one embodiment, the substance is drawn from the substance container 110 via wick 135 that is at least partially inserted at one or more points in the second end of the substance container 110. The wick 135 will continue to draw such that it is always fully saturated until the substance has been depleted.

The vaporization unit does not require a flame or an external heat source.

### Battery/Power/Activation Methods

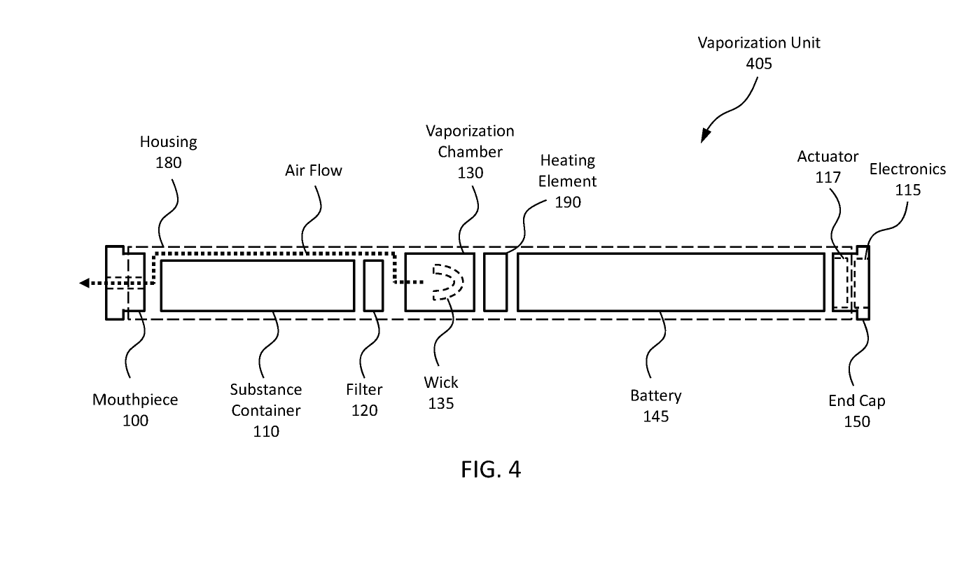

Referring to FIG. 4, the vaporization unit may be powered by battery 145 and/or an external power source. The battery 145 may be one of replaceable, rechargeable, or serve as a backup power system. The vaporization unit may include a built-in display for displaying a battery power level and/or may connect to a smart device that displays the battery level. Battery level may be indicated by an intermittent or continuous light display. The vaporization unit 405 may be powered by an external power source. It may plug into at least one of a wall outlet or USB charger. The charger or cable connection may be one of plugged in or magnetically attached.

A pressure sensor or print reader may be located on the mouthpiece 100 or located on some other location of vaporization unit 405 and may sense pressure or read print signatures from the fingers or lips to complete the power circuit or to power up the vaporization unit.

In operation of one embodiment, depicted in FIGS. 4 through 6, the user draws air in through the mouthpiece 100, which in turn generates air flow through an actuator 117 located at a second end of the vaporization unit. In one embodiment, the actuator 117 may sense the air flow, differential air pressure, or another parameter and in response complete an electrical circuit between the power source 140 and the heating element 190 to turn on an LED or other visual indicator 115 coupled to or integrated with the actuator 117.

In addition, the LED or other visual indicator 115 (alternatively referred to as electronics 115) may be configured to notify the user when the substance to be vaporized is depleted or nearly depleted such as, but not limited to, the LED blinking.

### End Cap

The end cap 150 may take a form such that it fits snugly in the second end of the vaporization unit housing 180. The primary purpose of the end cap 150 is to cover the second end of the vaporization unit to complete the enclosure of the primary components and, in some embodiments, to prevent tampering. The end cap 150 may be shaped to enclose a portion of electronics 115.

The end cap 150 may be entirely transparent or translucent or it may include a portion that is transparent or translucent. An LED in electronics 115 may be placed inside the end cap 150 such that when it is lit, it is visible from the outside. The LED may be any color and may indicate that the unit is currently activated.

### Airflow

The embodiment of FIG. 4 includes the substance container 110 of FIG. 2A. The vaporized substance will flow out of the vaporization chamber 130 up the side of the substance container 110 to the mouthpiece 100 for inhalation by the user.

An alternate embodiment of the vaporization unit may have a straw-like tube 105 placed near or within the substance container 110 (shown in FIGS. 2B and 2C) to facilitate the movement of the vaporized substance to the mouthpiece 100. When the substance is vaporized it will be drawn through the straw 105, past or through the substance container 110, and out of the mouthpiece 100. One embodiment of the substance container 110 is generally a cylinder having two ends placed separately from the straw 105. The separate straw allows the vaporized substance to flow past the substance container 110 to the mouthpiece 100.

As the vaporized substance travels from the vaporization chamber to the mouthpiece 100 it will cool. Various factors, such as the length of the airway and the vaporization temperature of the substance, will determine the overall exit temperature of the substance.

FIG. 4 is a side view of an embodiment of the vaporization unit. The depicted embodiment is cylindrically shaped and comprises a mouthpiece 100, a substance container 110 shaped as in FIG. 2A, filter 120, a vaporization chamber 130 with a wick 135, a heater 190, a battery 145, an end cap 150, electronics 115, an actuator 117, and a housing 180. The electronics 115 may comprise an LED and the processor 400. The preferred filter 120 comprises a polymer filter and a fibrous wicking filter. The figure is not to scale. The components are drawn as simplified blocks for clarity; they may take on more intricate shapes as needed to at least one of attach to one another, fit within the housing 180, and for mode of manufacture. The vaporization chamber 130 is shown as a single separate component; however, it may be made up of several components such as a heat shield and a wick holder, for example. Alternatively, if the housing 180 is heat resistant, the vaporization chamber 130 may be created by the space between the filter 120 and the heater 190. Additionally, there may be O-rings placed around components on either side of the vaporization chamber 130 in order to prevent oil leakage outside of the chamber 130.

FIG. 5 is an exploded top view of the embodiment of FIG. 4 in greater detail. The housing 180 has been omitted for clarity. In this embodiment, a heating element comprising a wire heating coil 195 is wrapped around the wick 135. The vaporization chamber 130 in this embodiment includes a heat shield 125 that extends over the wick 135, heating coil 195, wire leads 165, divider 175, and seats into a first end of a base 155. The metal heat shield 125 provides additional heat protection by diffusing the heat generated by vaporization. A first filter 120 is a thin polymer disk with a central hole and at least two equally spaced smaller holes surrounding it as shown in FIG. 3. A second filter 120 is comprised of a fibrous wicking material. In the depicted embodiment the filters 120 are generally circular and are shaped to fit snugly within the second end of the substance container 110.

In operation of a reusable embodiment, where liability and user accountability are not a concern, the user removes a mouthpiece 100 and takes out a substance container 110; opens the container 110 and fills or refills it with a desired amount of substance; inserts the substance container 110 back into the vaporization unit 405 and re-attaches the mouthpiece 100; and inhales through the mouthpiece 100 to close a connection between battery 145 and wires 165. The battery heats the heating coil 195 vaporizing substance from the substance container 110 that is drawn by a capillary action through filters 120 by wick 135 to heating coil 195. The vaporization of the substance causes wick 135 to draw additional substance from substance container 110 into vaporization chamber 130 and be vaporized by heating coil 195.

The vaporization unit 405 may be disposable. Disposable units may be used multiple times. As they are not refillable, they will likely be disposed of after the substance has run out. Depending on the amount of substance in the disposable units as well as the average amount consumed by the user in each use, the units may last through one or several uses. In a disposable configuration, a battery life of the battery 145 may be sufficient to vaporize the cannabis oil or other substance within the container 110 without being recharged or replaced.

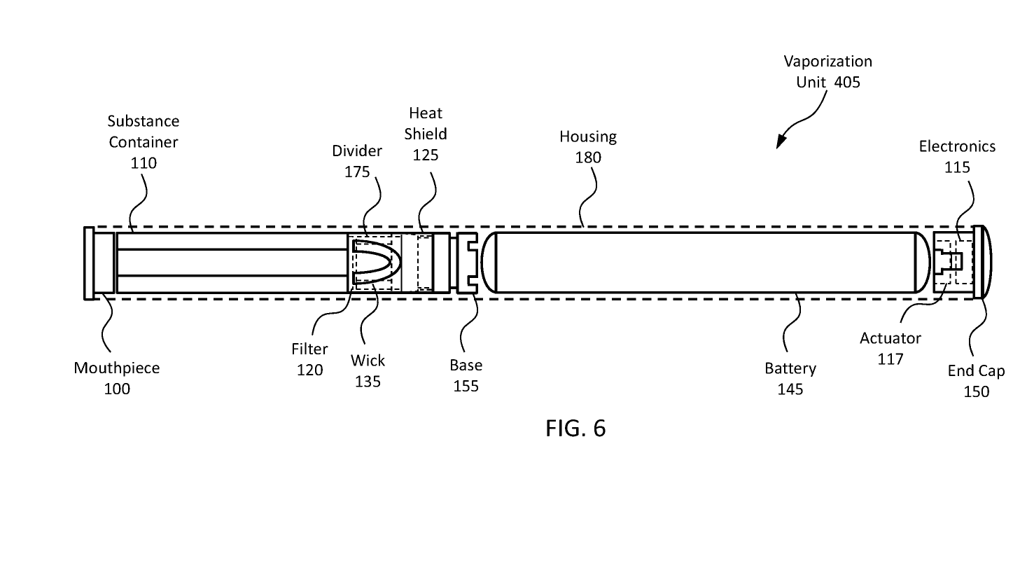

FIG. 6 is an assembled top view of the embodiment of FIGS. 4 and 5. In the depicted embodiment, when a consumer inhales from the mouthpiece 100, the pressure from the inhalation activates an actuator 117 which in turn activates the battery 145 thus powering up the vaporization unit 405. The electrical current from the battery 145 heats the bare wire that is wrapped around the saturated wick 135 (the heating coil 195) causing the substance to vaporize. As the substance vaporizes, and the consumer inhales, the vapor travels down the airway and out of the mouthpiece 100.

In the depicted embodiment, substance is held in the substance container 110. When the consumer inhales through the mouthpiece 100, the substance is pulled from the substance container 110 via capillary action, through the filters 120, and onto the wick 135 which is in contact with filter or filters 120. The material and porosity of the filter or filters 120 determines the rate at which the substance will flow. In other embodiments, the substance may be wicked directly from the substance container 110 by the wick 135 pressing directly against an opening in the end of substance container 110.

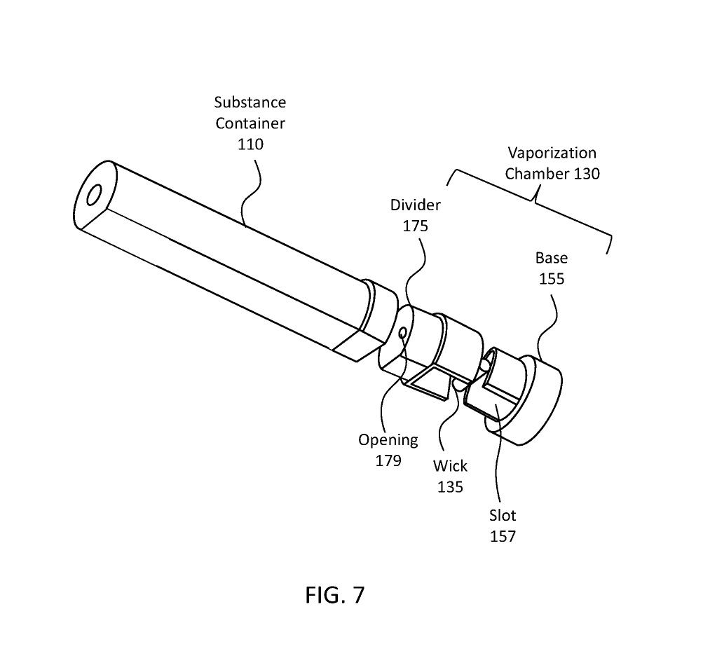

FIG. 7 depicts an isometric view of the embodiment of FIGS. 4 through 6 showing the detail of the substance container 110, divider 175, and the base 155. The embodiment depicts in more detail a circular substance container 110 with a flat edge and an opening from which the vaporized substance may be accessed. The divider 175 shows an opening 179 for the substance in substance container 110 to transfer through into a chamber containing wick 135 and coil 195 (FIG. 5) as well as the general design of the heat shield 125. The figure further shows the base 155 and the wick 135 in relation to one another with consideration to the heat shield 125. Slots 157 in divider 175 and base 155 provide an opening for the vaporized substance to flow out of the vaporization chamber up the side of substance container 110 and out the mouth piece 100 as shown in FIG. 4. The air flow created by the user inhaling on mouthpiece 100 also may create pressure in vaporization chamber 130 drawing more substance from substance container 110 into vaporization chamber 130.

### Additional Features and Components

Additional features may include one or more of a key ring attachment, lanyard, battery life indicator, rechargeable battery, USB charger, wall charger, interchangeable mouthpieces, replaceable LED with multiple color choices, viewing port for oil level, ability to detect substance container filler and heat appropriately, magnetic attachments (such as charger, mouthpiece, substance container, etc.), user programming control, smart device application for tracking usage and stats (much like FitBit), smart device application for controlling one or more aspects of the unit, and anti-microbial coatings on the mouthpieces, among other things. The connection to smart device may be Bluetooth, WiFi, NFC, or direct cable connection.

Various components and attachments may be one or more of screw on, snap on, or magnetic. One or more of the internal components such as battery, filter, substance container, heating element, etc. may be replaceable by the user or a registered vendor. The vaporization unit may also have a corresponding storage/carrying case.

The vaporization unit may be completely user programmable with the ability to program being at least one of built-in or via smart device application. Smart devices comprise smartphones, tablets, computers, televisions, appliances, and programmable household electronic control devices. The vaporization unit may be capable of detecting different inputs (leaves, oils, liquids) and heating appropriately. Additionally, the heating capabilities of the unit can be programmed or otherwise set to heat product to specific temperatures, thereby maximizing the user-benefit of certain therapeutic cannabis compounds, which are known to have different and distinct boiling points when vaporized, as described in further embodiments of this specification. The smart device may also be used for tracking, much like FitBit activity tracking, to track usage history, battery life, etc. An embodiment of the vaporization unit is tamper-proof.

### Part 2—Operation and Control

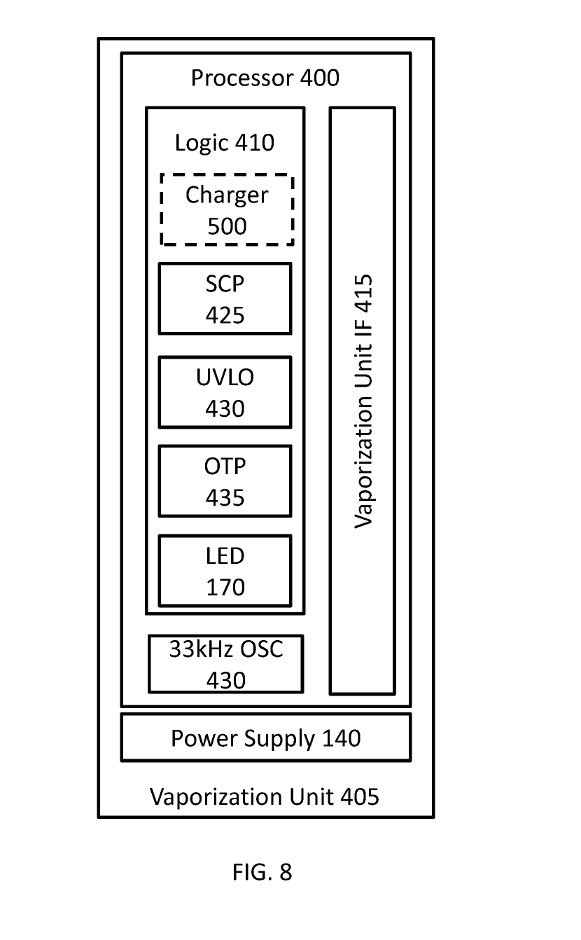

The following discussion refers to FIGS. 8 to 18.

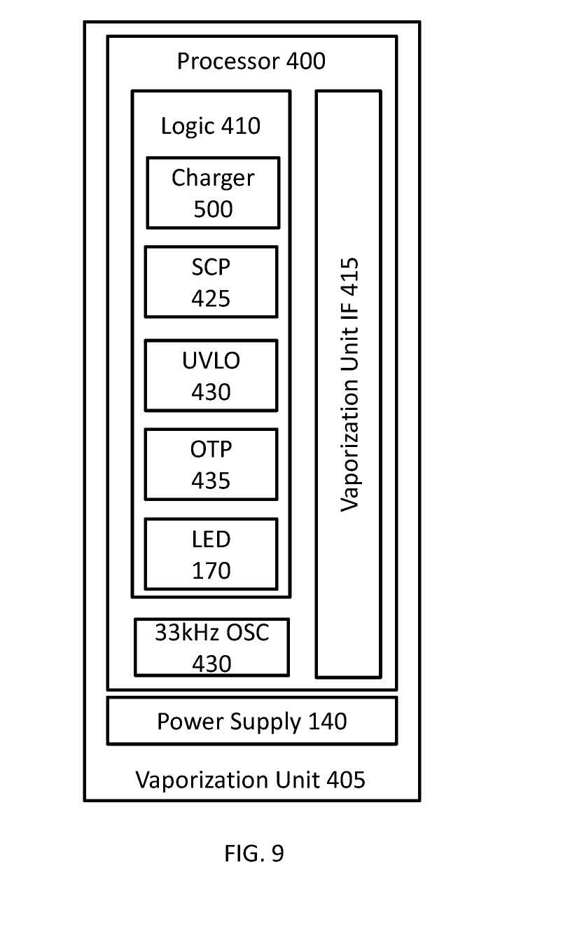

A processor 400 is included with within the housing of each vaporization unit 405. The use of a processor 400 is well known in the vaporization unit and electronic cigarette industry; its basic operation is depicted in FIGS. 8 and 9; where FIG. 8 depicts the typical processor architecture for a disposable vaporization unit 405 and FIG. 9 includes processor logic for both operating and charging a reusable vaporization unit 405. The basic difference of the two architectures is the addition of battery charger logic 500 in the processor 400 used for the reusable embodiment.

In both embodiments, the vaporization unit 405 interfaces with the processor 400 through the vaporization unit interface 415, the interface includes at least a connection to the power supply 140, the heating element coil 195 (FIG. 5); connection to a charger source (for reusable embodiments); and connection to an LED 170 (FIG. 1). The LED 170 (FIG. 1) indicator can be external or can be collocated with the processor 400. The processor 400 may be configured to control a flow rate of material from the substance container to the vaporization chamber by controlling the heating circuit to limit the length of time that the heating element is activated or the number of heating cycles per dose session.

For those embodiments that include charger logic 500, the processor 400 provides battery protection by intelligently managing charging performance during recharge operations. For those equipped to be recharged, the charging control 500 anticipates supporting an AC adapter, USB and other charging devices using a multi-mode charging logic, including:

trickle charge mode—where a trickle charge mode is implemented when battery voltage is under 2.7V, this is done for battery protection;

large charge current mode—when the battery voltage exceeds 2.7V, then the charging current starts to drop when the battery voltage approaches 4.2V; and

high voltage mode—for maintenance, all detection error is typically kept within a 1% tolerance.

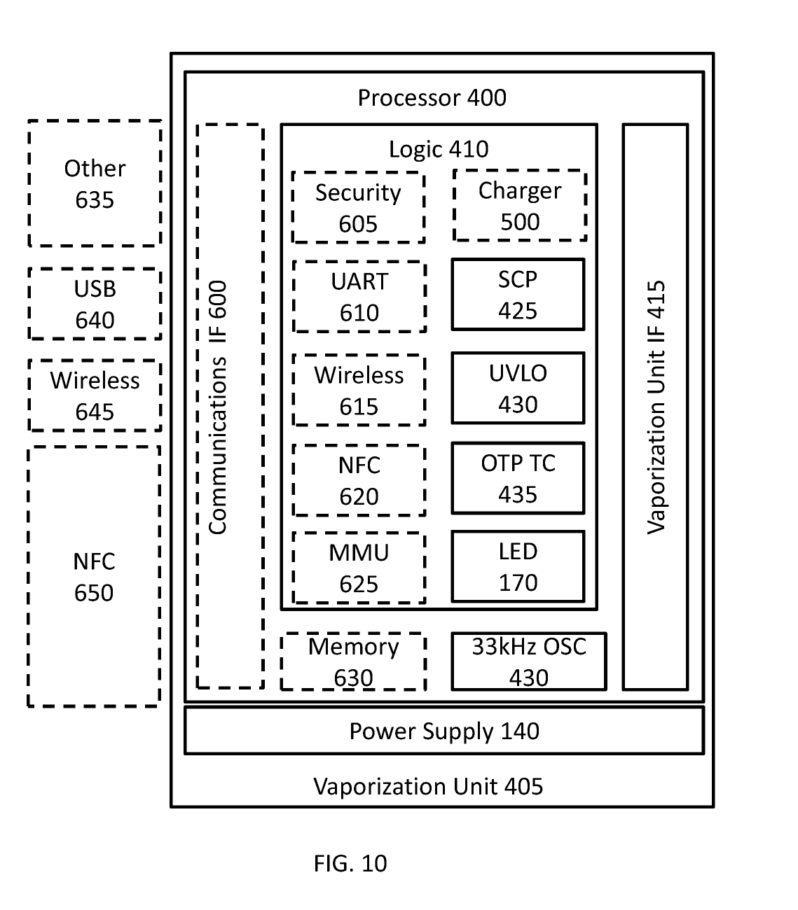

The underlying operational logic of existing microcontroller processors is highly limited and typically does not include provisions for communications, memory, connectivity to external devices, etc. FIG. 10 depicts what applicants term a next generation vaporization unit 405 processor 400. In addition to the logic blocks discussed above in FIGS. 8 and 9; FIG. 10 depicts an extended architecture with respect to hardware and logic to handle additional capability to include advanced power management schemes, multi temperature operating modes, medical dosing control, security to include user authentication and non-repudiation. Specifically with respect to non-repudiation; digital security services are included that provide proof of the integrity and origin of data as well as an ability to assert an authentication with high assurance that the data is genuine.

FIG. 10 shows the basic controller logic in the processor 400, this includes logic 410, vaporization unit interface 415, short circuit protection 425, under voltage lockout 430, over temperature protection and temperature control 435, LED logic 170, an oscillator 430, a power supply 140, memory 630, memory management unit (MMU) 625, and security block 605.

### Power Management

Today, the simplicity of the systems and their intended uses do not require extensive intervention or management of the unit by a processor. Operating modes including standby quiescent draw in a power-down mode are incorporated on most current processors, but a quiescent draw can be problematic. As an example, when a vaporization unit 405 is manufactured, it is delivered as a “hot” system running at quiescent amperage; all connections have been made, tested and are ready for the end use. These units at power-down typically achieve a quiescent current of 3-5 μA; it is estimated that at best on a typical disposable vaporization unit 405 using a 170 mA battery, 15-20% can degrade annually while being stored or shipped to a filling facility or shop for sale. Therefore shelf life of these hot vaporization units 405 operating in a standby mode for extended periods of time is problematic for the disposable industry.

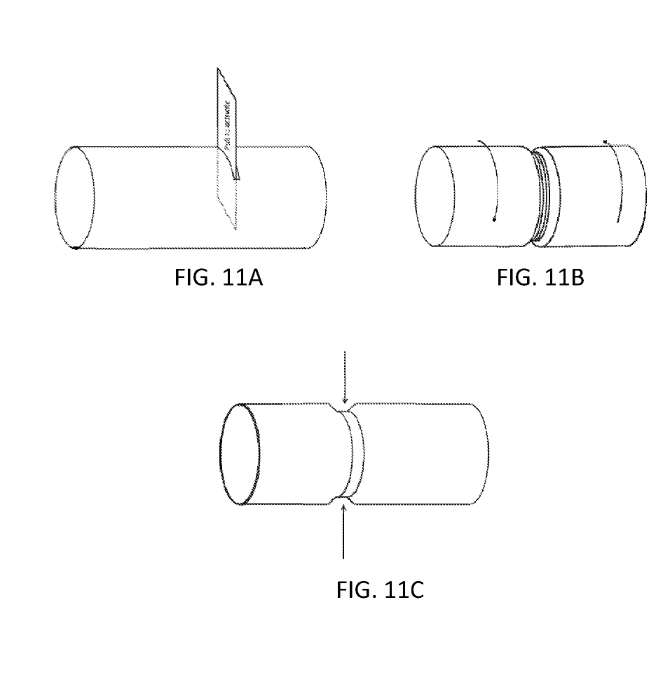

To solve the problem of shelf life, the vaporization unit 405 uses an activation step. FIG. 11 depicts possible activation mechanisms for managing power of the battery to extend the shelf life of the unit. FIG. 11A uses a string or tab placed between two contact strips, such that when pulled, the contacts are closed resulting in activation of the processor 400. The contact strips can be integrated into the fill end of the vaporization unit 405, or into the surface of the outer housing. FIG. 11B shows a twisting action that when the user engages it the circuit will be closed and the unit can be used. Alternately, the two metal strips can be integrated into the unit housing, such that at time of filling, a mechanical action can squeeze or crimp a certain section of the outer skin such that a contact is instantiated between the two metal strips of the battery switch during a filling operation, as shown in FIG. 11C. There are many other methods, not shown, that could be implemented to complete an internal circuit so as not to drain battery when it is not in use.

### Communications

There are many forms of communications ranging from powered transceivers that include Bluetooth, 802.11x, Zigbee, etc. to non-powered systems like near field systems; these near field systems include Radio-Frequency Identification (RFID) and Near Field Communications (NFC). NFC transceivers include both powered and non-powered devices, however, the key to NFC is an ability to transmit and receive communications, essentially an RFID that one can read and write to.

The vaporization unit industry and particularly disposable vaporization units come with significant constraints including power, cost and size. NFC devices have evolved now to the point that they do not require power, they range in size down to 2-3 mm and cost less than 10 cents US; the use of these in an embodiment discussion does not preclude the use of powered system like Bluetooth for non-disposable units.

### Near Field Communication

As background, NFC is a form of short-range wireless communication where the antenna is much smaller than the wavelength of the carrier signal, thus preventing a standing wave from developing within the antenna, and so in the near-field the antenna can produce either an electric field, or a magnetic field, but not an electromagnetic field when the receiver is within the transmitters near field. NFC communicates either by a modulated electric field, or a modulated magnetic field, but not by radio (electromagnetic waves). For example, a small loop antenna (also known as a magnetic loop) produces a magnetic field, which can then be picked up by another small loop antenna, if it is near enough.

Magnetic NFC has a useful property of being able to penetrate conductors that would otherwise reflect radio waves. For example, magnetic NFC was once used for communicating with submarines while they are submerged because the magnetic flux lines can penetrate conductive sea water. But in this case the frequency had to be extremely low in order to make the wavelength long enough (hundreds of miles) to be useful for submarines.

Some mobile phones now use electric-field NFC that operates at a frequency of 13.56 MHz, corresponding to a wavelength of 22.11 m. These short range communications are used for certain special transactions because the very short range of NFC makes it difficult to eavesdrop on. To efficiently generate a far-field, which means to send out radio waves of this wavelength, one would typically need an antenna of a quarter wavelength, in practice a meter or more. If the antenna is just a few centimeters long, it will only set up the so-called ‘near-field’ around itself, with length, width and depth of the field roughly the same as the dimensions of the antenna. Very little energy will radiate away, it is essentially a stationary electromagnetic field pulsating at 13.56 MHz. If another similarly small antenna is brought into this field, it will induce an electric potential, alternating at the same frequency. By modulating the signal in the active antenna, one can transmit a signal to the passive, receiving antenna. Present and anticipated applications include contactless transactions, data exchange, and simplified setup of more complex communications such as Wi-Fi. Communication is also possible between an NFC device and an unpowered NFC chip, called a “tag”.

NFC always involves an initiator and a target; the initiator actively generates a radio frequency (RF) field that can power a passive target. This enables NFC targets to take very simple form factors such as tags, stickers, key fobs, or cards that do not require batteries. NFC peer-to-peer communication is possible, provided both devices are powered.

NFC tags contain data and are typically read-only, but may be rewriteable. They can be custom-encoded by their manufacturers or use the specifications provided by the NFC Forum, an industry association charged with promoting the technology and setting key standards. The tags can securely store personal data such as debit and credit card information, loyalty program data, PINs and networking contacts, among other information. The NFC Forum defines four types of tags that provide different communication speeds and capabilities in terms of configurability, memory, security, data retention and write endurance. Tags currently offer between 96 and 4,096 bytes of memory. NFC communications protocols and data exchange formats are based on existing RFID standards as outlined in ISO/IEC 18092:

NFC-A based on ISO/IEC 14443A;

NFC-B based on ISO/IEC 14443B; and

NFC-F based on FeliCa JIS X6319-4.

NFC-enabled devices support three operating modes:

Reader/Writer: Compliant with the ISO 14443 and FeliCa specifications, the NFC device is capable of reading a tag (an unpowered NFC chip) integrated, for example, in a smart poster, sticker, or key fob;

Peer-to-Peer: Based on the ISO/IEC 18092 specification, two self-powered NFC devices can exchange data such as virtual business cards or digital photos, or share WLAN link setup parameters; and

Card Emulation: Stored data can be read by an NFC reader, enabling contactless payments and ticketing within the existing infrastructure.

NFC devices must conform to the NFC Forum's published specifications in order to ensure interoperability. These specifications define important RF measurements for NFC devices in active polling mode and in passive listening mode, which require a signal generator to generate the polling commands and listener responses, and an analyzer to measure the waveforms from the NFC device under test. Also needed are an NFC reference polling device and an NFC reference listening device, acting as initiator and target, respectively, for the device under test.

As the number of available NFC-enabled mobile phones and tablets increases, the market will see a growth in applications such as mobile payments, ticketing, smart posters, as well as access control, data sharing and additional services.

NFC point-to-point communications always require an initiator and a target. For active communications between two powered NFC devices, the initiator and target alternately generate their own fields. In passive communications mode, a passive target such as a tag draws its operating power from the RF field actively provided by the initiator, for example an NFC reader. In this mode an NFC target can take very simple form factors because no battery is required.

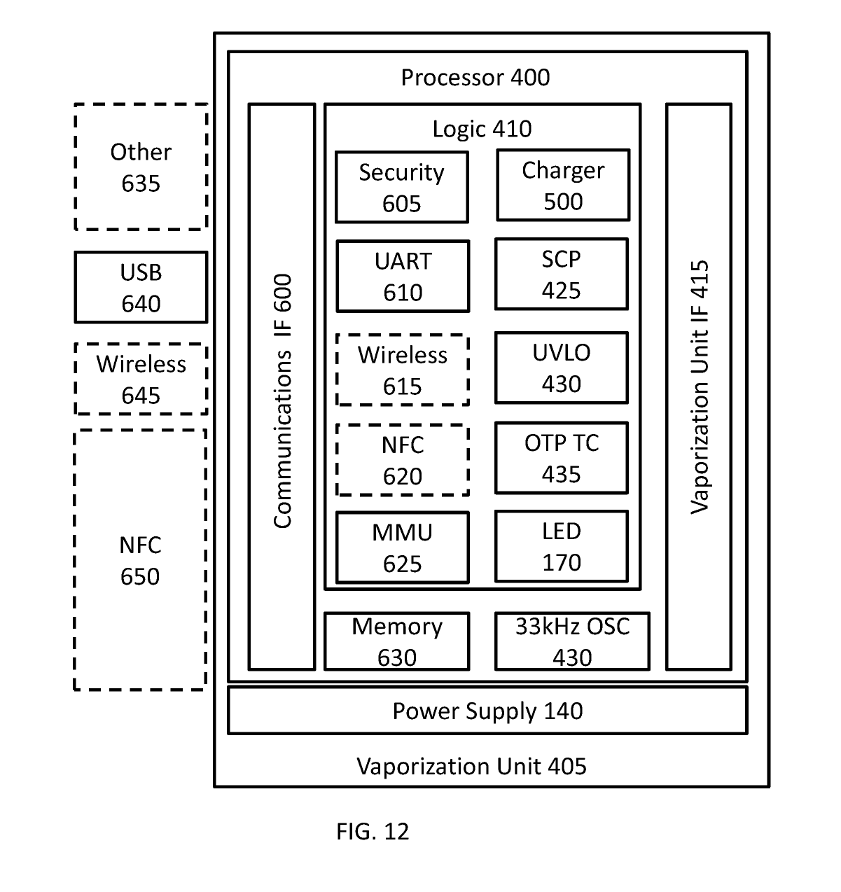

FIGS. 12 through 14 depict a modular and extensible controller logic. This architecture allows different options and operations based on the options selected and used. FIG. 12 depicts a USB implementation. For this embodiment additional elements are included to support both USB 640 communications through a Universal Asynchronous Receive and Transmit (UART) 610 for communicating through the USB connection 640 and USB charging logic 500 for non-disposable operations.

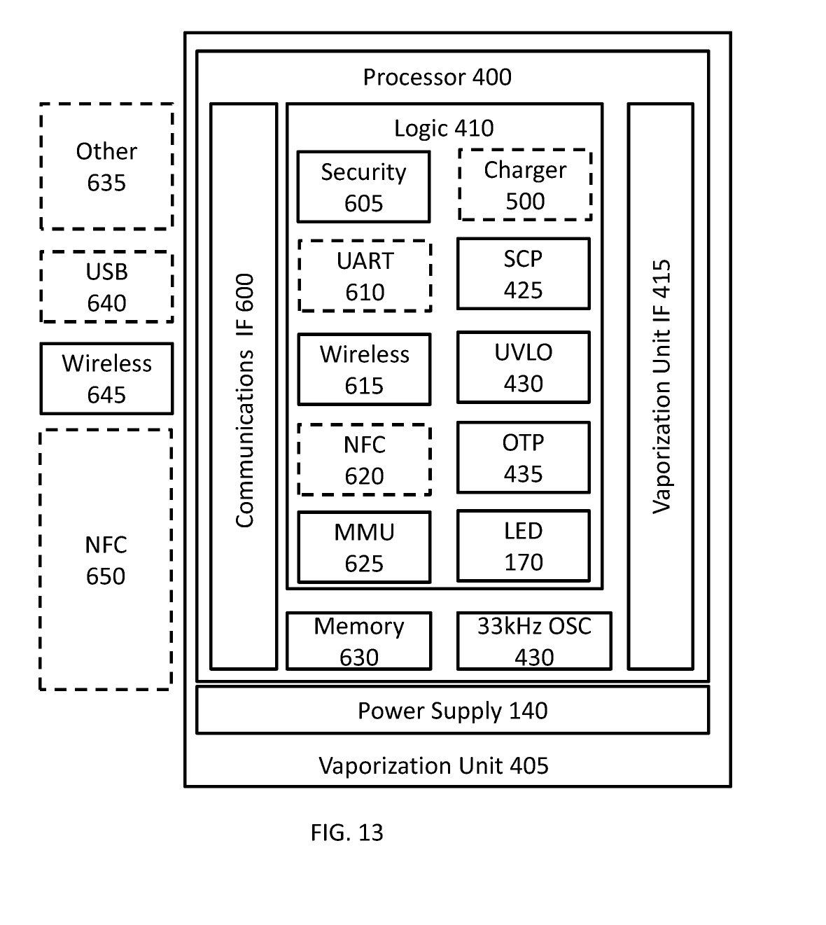

FIG. 13 depicts a wireless embodiment using protocols such as Bluetooth or 802.11.

Specification of the Bluetooth System Versions: 1.2 dated Nov. 5, 2003; 2.0+EDR dated Nov. 4, 2004; 2.1+EDR dated Jul. 26, 2007; 3.0+HS dated Apr. 21, 2009; and 4.0, dated 17 Dec., 2009 is incorporated by reference and is therefore not described in further detail. IEEE 802.11n specification for Wireless Local Area Networks dated 29 Sep., 2009 is incorporated by reference and is therefore not described in further detail.

In the Bluetooth embodiment, one or more processors in the multiprocessor network are configured to operate a Bluetooth transceiver 615 which is configured to detect and establish communication between the multiprocessor network and the vaporization unit 405 in proximity to the multiprocessor network. Once detected, the new vaporization unit 405 is selectively connected to the multiprocessor network. The selected processors are configured to run the software application, where running the software application causes the selected processors to take over control and operation of the vaporization unit 405 including initiating transfer of the data from the vaporization unit 405. The foregoing steps of securely adding a new device to a system of one or more processors is called a Dynamic Configuration System or DCS.

In further discussion of the Bluetooth embodiment, once a vaporization unit 405 is securely connected, the system operates a logging manager in at least one of the multiprocessors configured to monitor data from the processors and identify certain data for logging from the processors, wherein the certain data is logged from different sensors. Once logged, the data is stored in a memory 630, wherein the stored data is based on a pre-determined condition and responds to an outgoing message from the software application for sending out over the Bluetooth link 615 to another processor, wherein the logging manager sends at least a portion of the logged certain data retrieved from the memory 630 based on the pre-determined condition.

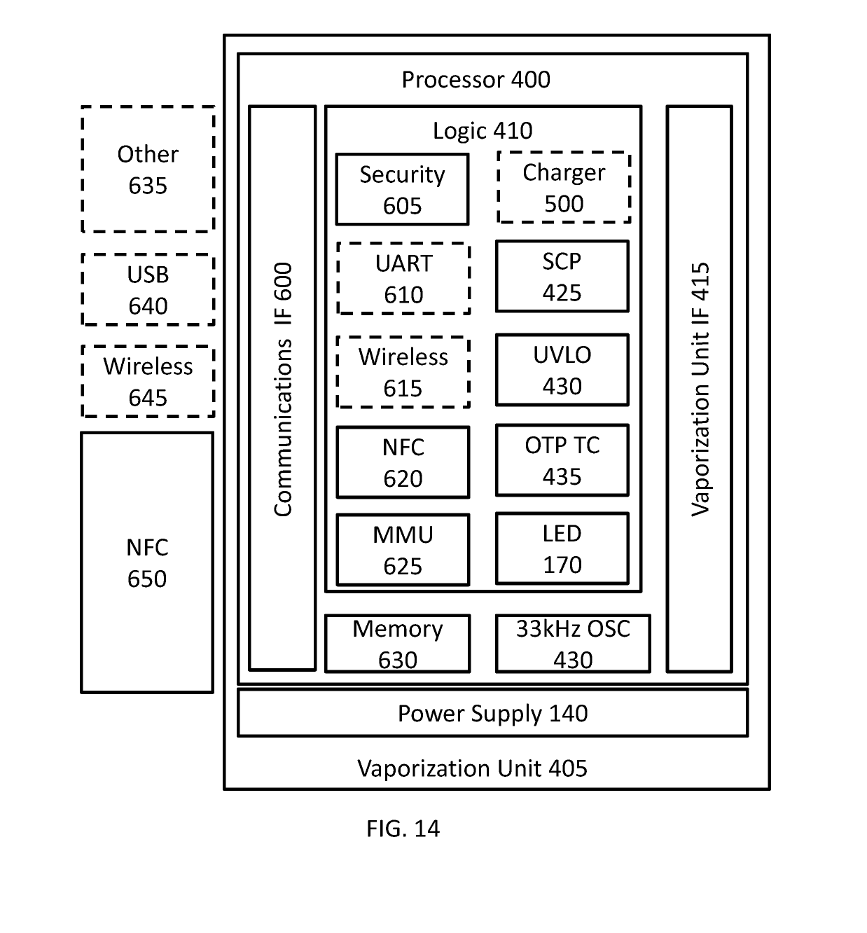

FIG. 14 depicts using an NFC transceiver 650 for two-way (point-to-point) interactions between the vaporization unit 405 and a smart device equipped with an NFC transceiver. In alternate embodiments, the smart device could be a smartphone, tablet, computer, point of sale register, or a filling machine for contactless transactions, data exchange, and operational setup.

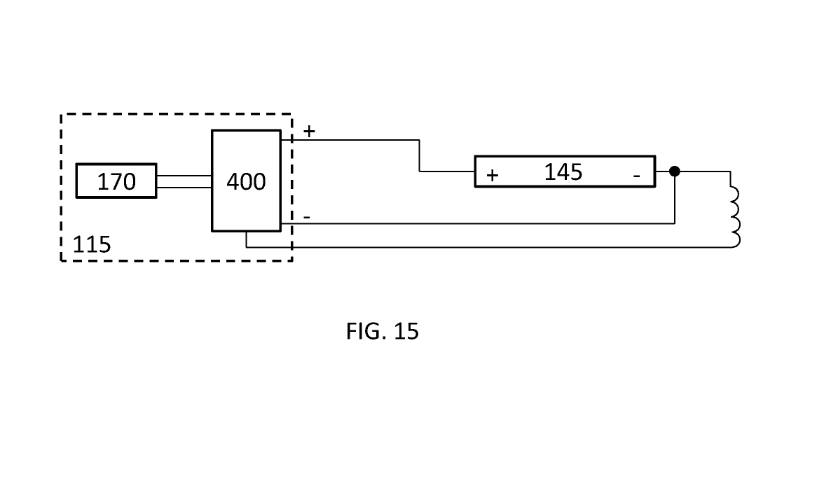

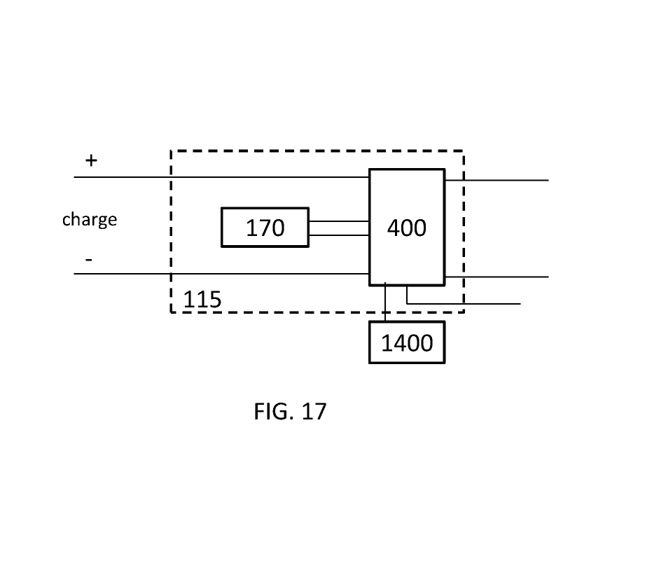

FIG. 15 depicts a schematic for a disposable embodiment with generalized circuitry. It can be noted that the battery 140 is connected to the LED 170 at two points. In some embodiments, a portion of the circuit may include a break or a switch to activate and deactivate the circuit resulting in longer shelf life for the battery 140 and the LED 170 (depicted in FIG. 17).

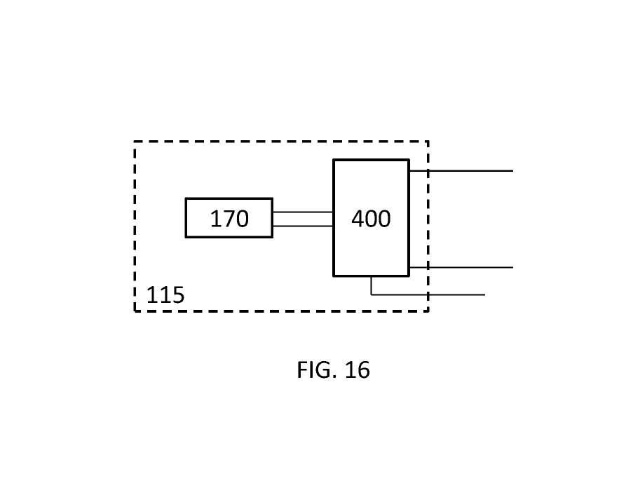

FIG. 16 depicts a schematic for a disposable embodiment. The LED 170 can be combined with the processor 400 forming the electronics 115 (FIGS. 4-6). When the activation switch 1100 is closed, the circuit is completed and the battery 145 supplies power to the circuit.

FIG. 17 depicts a schematic for a reusable embodiment. The reusable embodiment includes a charger, which will allow for multiple uses.

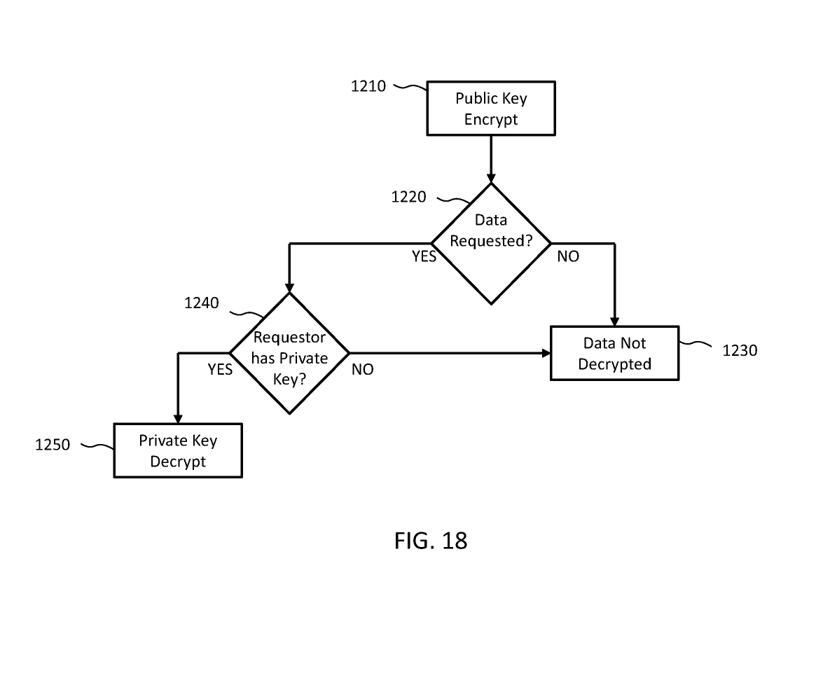

FIG. 18 depicts a schematic for a reusable embodiment including an activation switch 1400. The activation switch 1400 is a portion of the circuit that requires a connection to be made to allow the activation of the device. The activation switch 1400 can be a single use or multi use switch that can be initiated by actions such as a pull tab, a button, crimping the device, twisting the device, etc., as shown in FIG. 11.

### Security

Near field communication has a maximum working distance of less than 20 cm. This short distance increases security by only allowing devices that are in close proximity to communicate with each other, thus eliminating or reducing accidental or malicious communication with nearby devices.

Regardless of the communications link established for the vaporization unit 405 security considerations for sensitive information will be of a paramount concern. In accordance with another embodiment, systems and methods are provided to enhance security and convenience during operations of the vaporization unit 405. One example is using a smart device and a secure application developed specifically for security; including a setup process that needs to occur only once (but may occur more often according to user preferences or requirements). An individual can link their biometric ID with account information tied directly to the vaporization unit 405 that is located in a security module 605. The security module 605 will be a key aspect of liability and risk management with respect to reporting, authentication and data surety for the manufacturer or the point of sale vendor where the oil is loaded into the vaporization unit 405.

Considerations for the exchange of secure information between an identified individual and the vaporization unit 405 using encryption of all of the transmitted and received data is included. Data encryption has a long history that pre-dates the invention of the electronic computer. A number of well-established methods have been developed to protect the confidentiality, integrity and authenticity of data.

Most encryption techniques make use of one or more secret keys or security codes that can be used to encrypt and/or decipher data streams. Keys used to encode or decipher data streams can originate from a number of sources including previously transmitted data sequences, identification codes embedded during the manufacture of a unit, and usage counts.

Encryption and deciphering methods that make use of transposition, substitution, repositioning, masking, translation tables, and/or pre-defined numeric sequences are well-known in the art. More sophisticated techniques utilize multiple methods applied to larger blocks (i.e. more than a single character or byte) of information. In addition, encryption and deciphering methods that include a processing step within a protected hardware component are generally more protected from attempts at decoding compared to those implemented using software stored on some form of memory device.

Generally, public-key cryptography, also known as asymmetric cryptography, is a class of cryptographic algorithms which require two separate keys, one of which is secret (or private) and one of which is public. Although different, the two parts of this key pair are mathematically linked. The public key is used to encrypt plaintext or to verify a digital signature; whereas the private key is used to decrypt cipher text or to create a digital signature. The term “asymmetric” stems from the use of different keys to perform these opposite functions, each the inverse of the other—as contrasted with conventional (“symmetric”) cryptography which relies on the same key to perform both.

Public-key algorithms are based on mathematical problems which currently admit no efficient solution that are inherent in certain integer factorization, discrete logarithm, and elliptic curve relationships. It is computationally easy for a user to generate their own public and private key-pair and to use them for encryption and decryption. The strength lies in the fact that it is “impossible” (computationally infeasible) for a properly generated private key to be determined from its corresponding public key. Thus the public key may be published without compromising security, whereas the private key must not be revealed to anyone not authorized to read messages or perform digital signatures. Public key algorithms, unlike symmetric key algorithms, do not require a secure initial exchange of one (or more) secret keys between the parties.

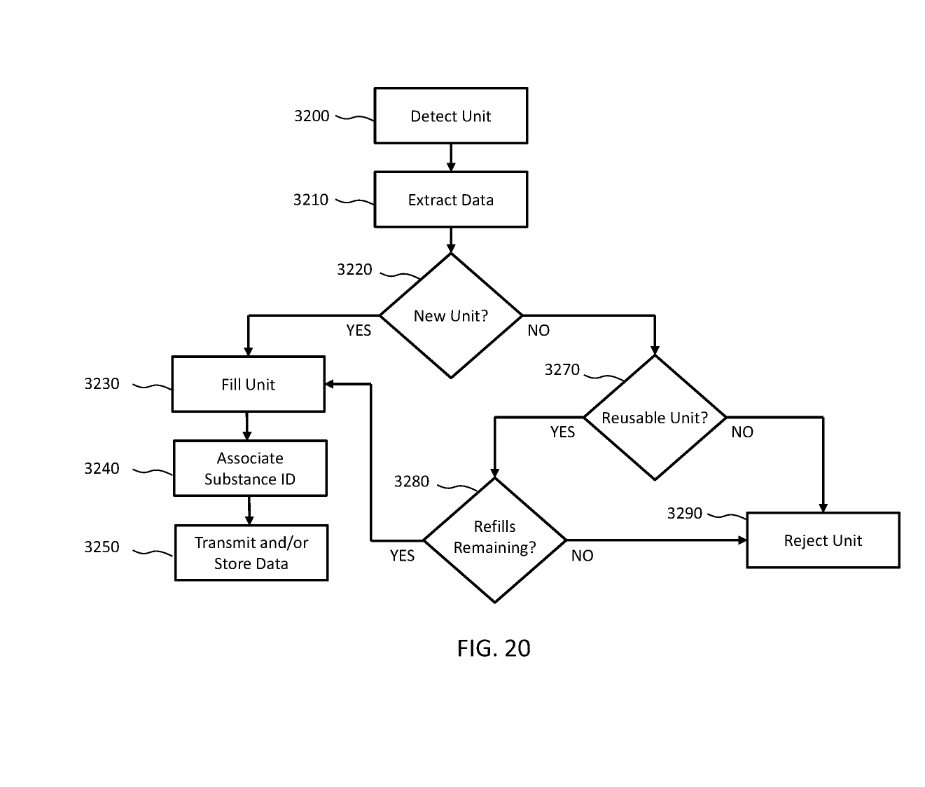

The vaporization unit 405 can be used to communicate with a second device, like a smartphone, a computer, or other device equipped with a communications system for data transfer, transactions, reporting, etc. (FIG. 20). With a focus on smart devices (such as smartphones, mobile tablets, smart TVs, and other “smart” appliances), and particularly the security aspects, biometric data of an authorized user can be generated by the smart device running a software application. It could be an image of the user or a part of the user's body such as face and facial recognition, eye and iris identification, or fingerprint recognition, as used in modern smartphones. Biometric data is capable of generating a secure low complexity public key/private key relationship such that it would be impossible for anybody other than the originator of the private key to access to the user's information.

FIG. 18 depicts the standard encryption process between two systems. The outgoing data is encrypted using a public domain key 1210. If data is requested 1220 the system will prompt for authorization 1240. Without authorization then the data will not be relayed 1230. Authorization is determined by the presence of a private key. If the data requestor is in possession of a private key he may use it decrypt 1250 the data. If the data requestor is not in possession of the private key then he will not be able to decrypt the data 1230.

Biometric identifiers are the distinctive, measurable characteristics used to identify and differentiate individuals. Biometric identifiers are often categorized as physiological versus behavioral characteristics. Physiological characteristics are related to the shape of the body. Examples include, but are not limited to fingerprint, palm veins, face recognition, DNA, palm print, hand geometry, iris recognition, retina, facial recognition, and odor/scent.

The system performs a one-to-one comparison of a captured biometric with a specific template stored in a biometric database in order to verify the identity of the individual. Positive recognition prevents multiple people from using the same identity. The first time an individual uses a biometric system is called enrollment. During the enrollment, biometric information from an individual is captured and stored. In subsequent uses, biometric information is detected and compared with the information stored at the time of enrollment. Note that it is crucial that storage and retrieval of such systems themselves be secure if the biometric system is to be robust. During the enrollment phase, the template is simply stored somewhere in memory of the smart device. During the matching phase, the obtained template is passed to a matcher that compares it with other existing templates, estimating the distance between them using the appropriate algorithm(s). The matching program will analyze the template with the input. This will then be output for any specified use or purpose.

As an example, the user's IrisData, referred to as ID, represents a unique aspect of biometric data, one that can be represented as a 375 bit encryption key. In another embodiment, the ID can be transferred to the processor where certain code is stored in the processor to generate the public key/private key relationship unique to the user. By placing the algorithms in the processor of a smart device, it is far less likely any user public key can be reverse engineered resulting in the user's ID is being compromised. The processor also contains flash memory that could be used to store the user's raw ID and ID_PrivateKey permanently. Additional memory may be provided for additional users as required.

### Activation and Filling of the Vaporization Unit

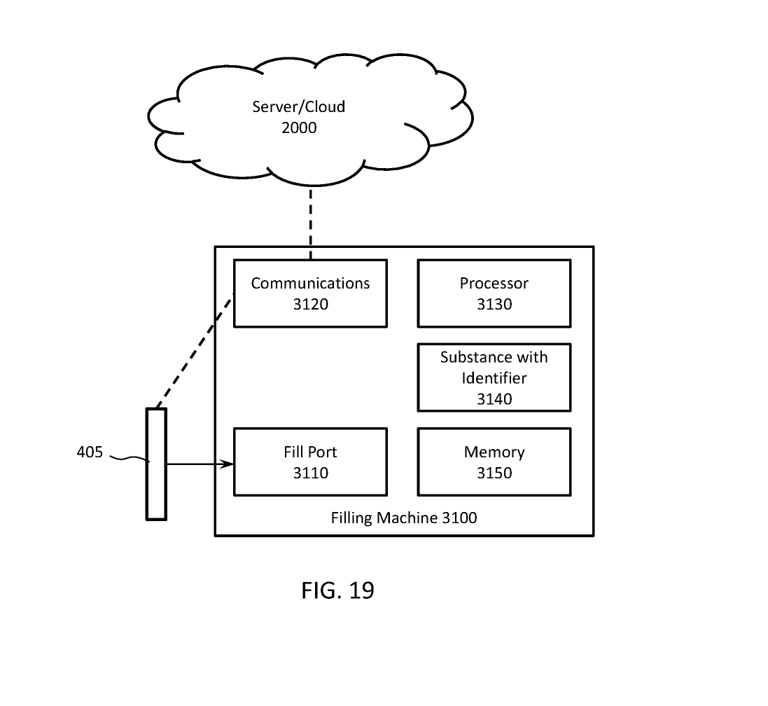

Referring to FIGS. 19 and 20, the filling machine 3100 will comprise a port 3110 configured to receive an empty vaporization unit 405 for filling, a memory 3150, a processor 3130, the fill substance with associated identifier 3140, and a communications system 3120. When the vaporization unit 405 is placed in the filling machine 3100 for filling, the filling machine 3100 will extract data from the vaporization unit 405 comprising at least one of the unit ID, universally unique identifier (UUID), and usage history. The vaporization unit 405 data will be associated with the filling substance identifier and at least one of stored in memory 3150 and transmitted to cloud or server 2000.

When the filling machine detects a vaporization unit 3200 that is ready to be filled, it will first extract data 3210 from the unit comprising at least one of the unit ID, associated UUID, and usage history. The extracted data may be compared to a database on an external server or the cloud and confirmed. Should the unit data be checked against a database, the unit may be rejected if it has any information associated with it that does not coincide with data retrieved from the cloud, server, or memory. If the vaporization unit 405 has been used before and is disposable 3280, it will be rejected 3290. If the vaporization unit has data associated with it regarding allowed number of refills 3285, and has already reached its allotment, the filling machine will reject the unit 3290. If the vaporization unit is either new 3220 or is reusable 3270 and has refills remaining 3280, it will be filled 3230. Either during or after filling, the substance identifier will be associated with the unit data 3240 and then either transmitted to an external server or cloud, stored in local memory, or both transmitted and stored 3250. Many vaporization units will be single-use. The filling machine may reject vaporization units if it detects residual substance from a previous filling.

### Authentication and Use of the Unit

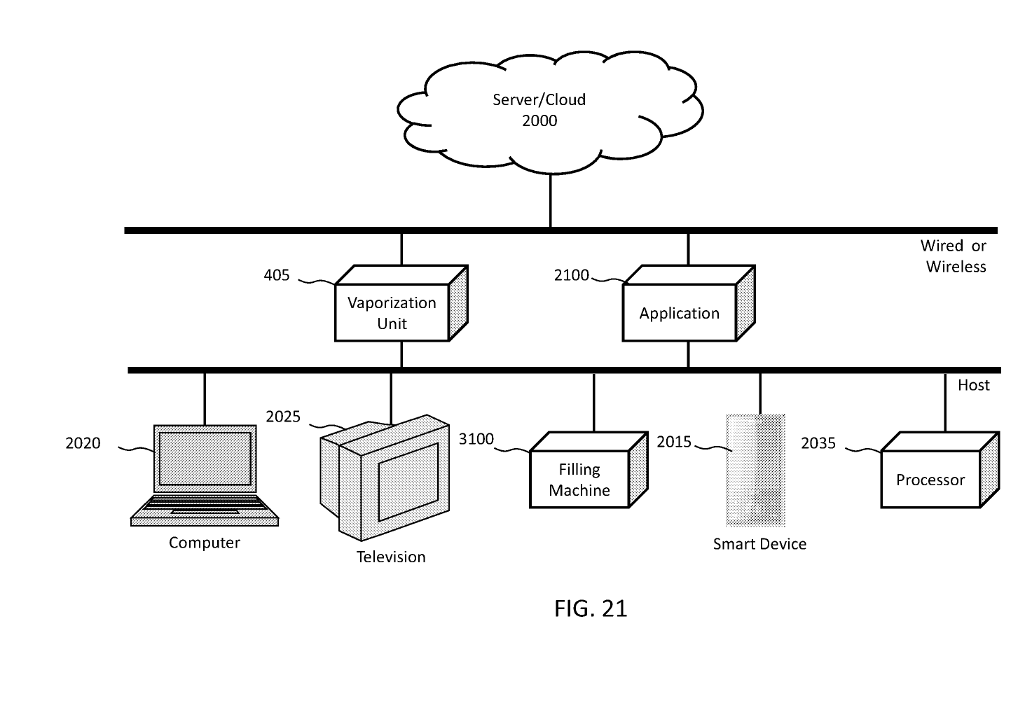

Referring to FIG. 21, a vaporization unit 405 may communicate with one or more of a filling machine 3100, smart device 2015, computer 2020, television 2025, or other appliance. The smart device 2015, computer 2020, television 2025, or appliance may serve as the whole or a part of the authentication scheme which activates the vaporization unit 405 for use by a user. For clarity the one or more of a smart device 2015, computer 2020, television 2025, or appliance will be represented by a smartphone for the remainder of the discussion. Communication between the smartphone and the vaporization unit 405 may be one of wired, wireless, Bluetooth, or near-field, with near-field being the preferred embodiment.

The smartphone may provide additional functionality and control to the vaporization unit. The smartphone may also serve as the authentication system and security measure in order to only authenticate and activate the unit for the registered user.

There may be an application 2100 on the network or on the smartphone through which various parameters of the vaporization unit may be adjusted or controlled. The smart device application 2100 may also serve to track usage history much like the health tracking capabilities of FitBit. The application may also provide data to the user in the form of at least one of email, text message, visual display, and haptic feedback. Data provided by the application may comprise usage history, power level, and substance level. If the vaporization unit is being used as part of a prescription, the application may also allow the user to see their current prescription status. The application may provide reminders to the user particularly if the substance is a prescription.

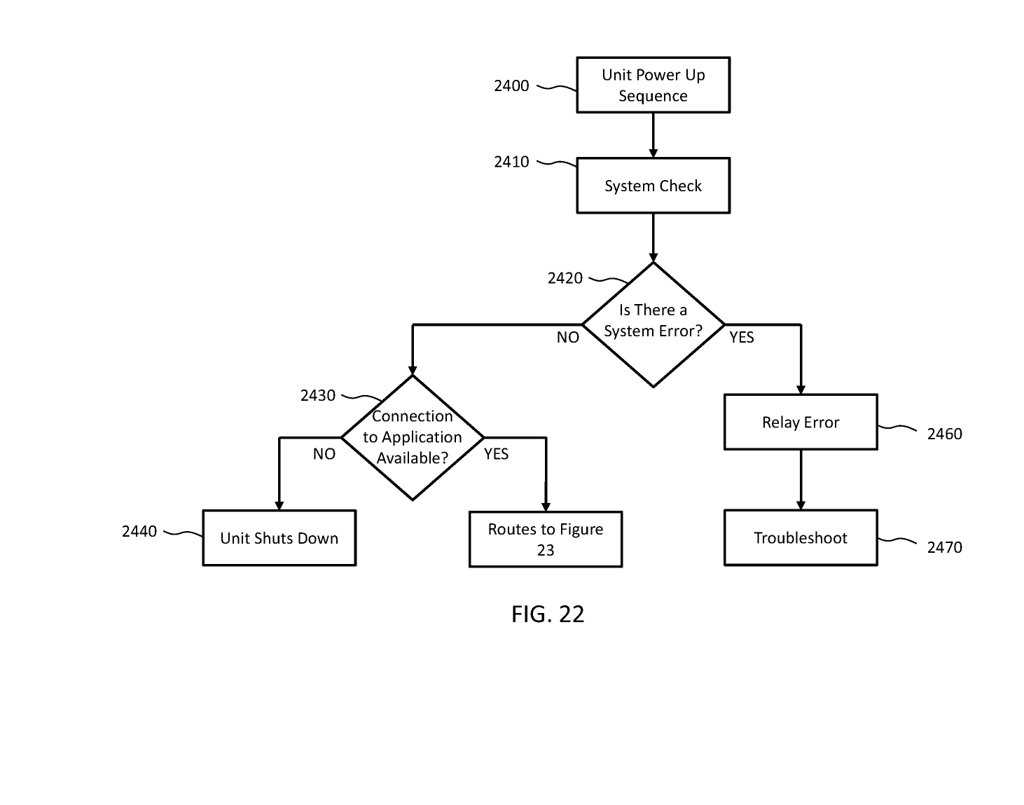

Referring to FIG. 22, when the vaporization unit is powered 2400 it may automatically run a system check 2410 to determine if it is running properly. If there is a system error 2420 the error will be relayed 2460 to the smart device application and the unit will enter troubleshooting mode 2470. It should be noted that the unit may not run the system check every time it is activated. A system check can be run manually at any time or it may be scheduled to occur at intervals such as every five uses or once a week. If there is not a system error 2420, the vaporization unit 405 will seek to connect with the application 2430 for authentication. If the unit cannot connect to the application, it will shut down 2440.

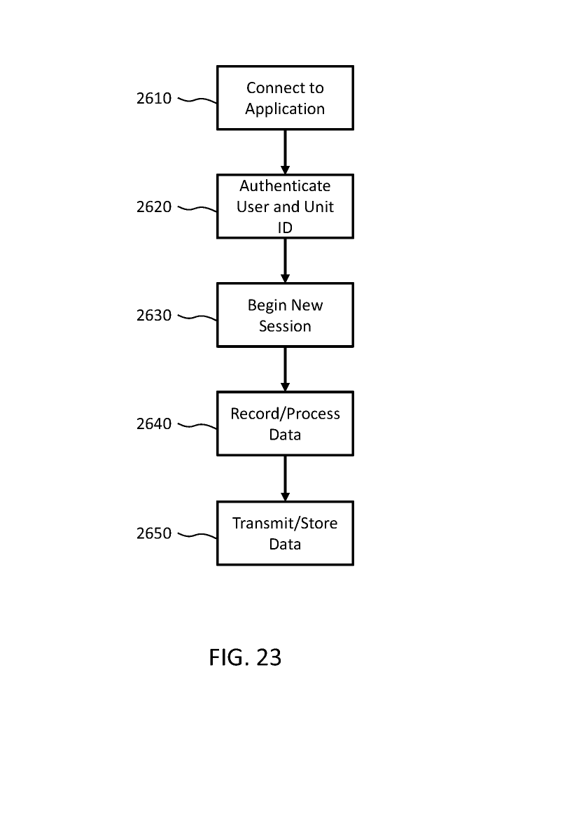

Referring to FIG. 23, if a connection is found the unit will connect to the application 2610. Once connected, the application will authenticate the user and the vaporization unit ID 2620 before allowing use of the unit. When both the user and the vaporization unit are authenticated, the user may begin a new session 2630. During use the application may record and/or process the data 2640. After use the application will perform one of store the data locally, transmit the data to a server or cloud, or both store the data locally and transmit the data to a server or the cloud 2650.

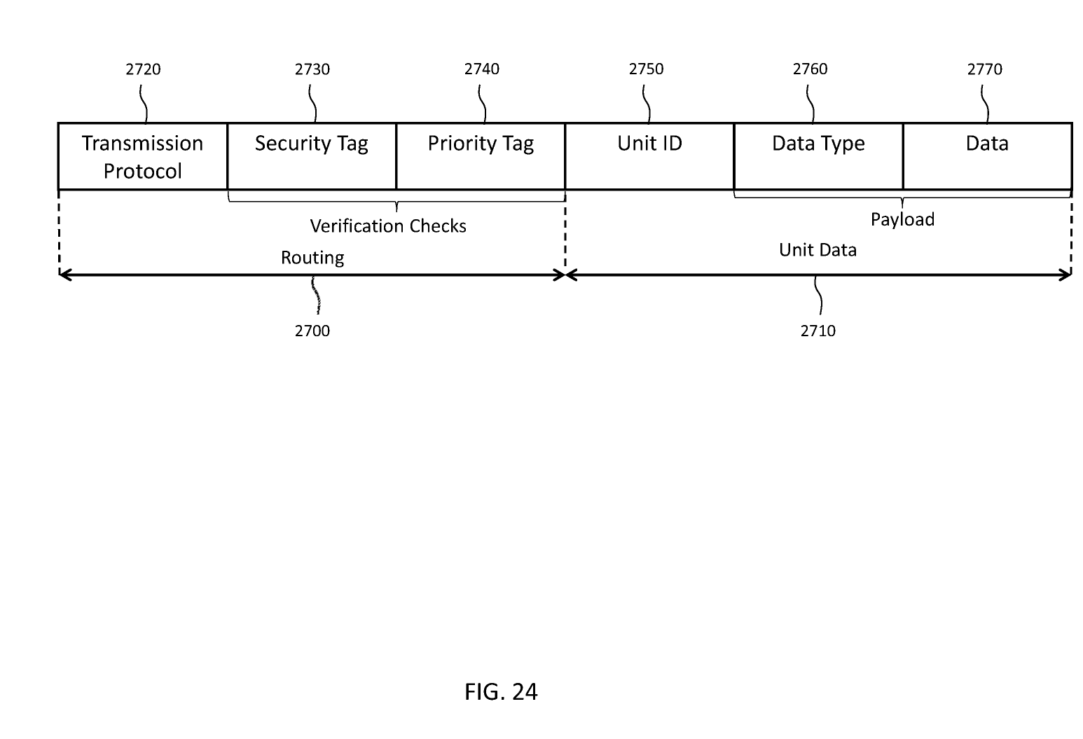

FIG. 24 depicts elements of a transmission data packet. The diagram can include all components listed, but may vary according to the needs of connected applications and vaporization unit types (i.e. medical, recreational, disposable, reusable, etc.). When a vaporization unit transmits a data packet, the routing 2700 portion will comprise at least one of the transmission protocol 2720, the security tag 2730, and the priority tag 2740. The transmission protocol 2720 can vary based on the network used to connect the vaporization unit(s) to the application. The security tag 2730 and the priority tag 2740 are detectable by any smart device, and can be modified based on the packet destination, or in the case of priority, different packet handling techniques. Error messages or emergency information can be decomposed and transmitted differently by the smart device running the application. The security tag 2730 will be used to prevent unauthorized access or use of the personal information including, but not limited to all of the unit data 2710. Unit data 2710 comprises the unit ID 2750 and the payload, comprising of data type 2760 and the data 2770. The unit ID 2750 identifies the vaporization unit and allows connected applications to locate drivers or files pertinent to data 2770 interpretation and allocation.

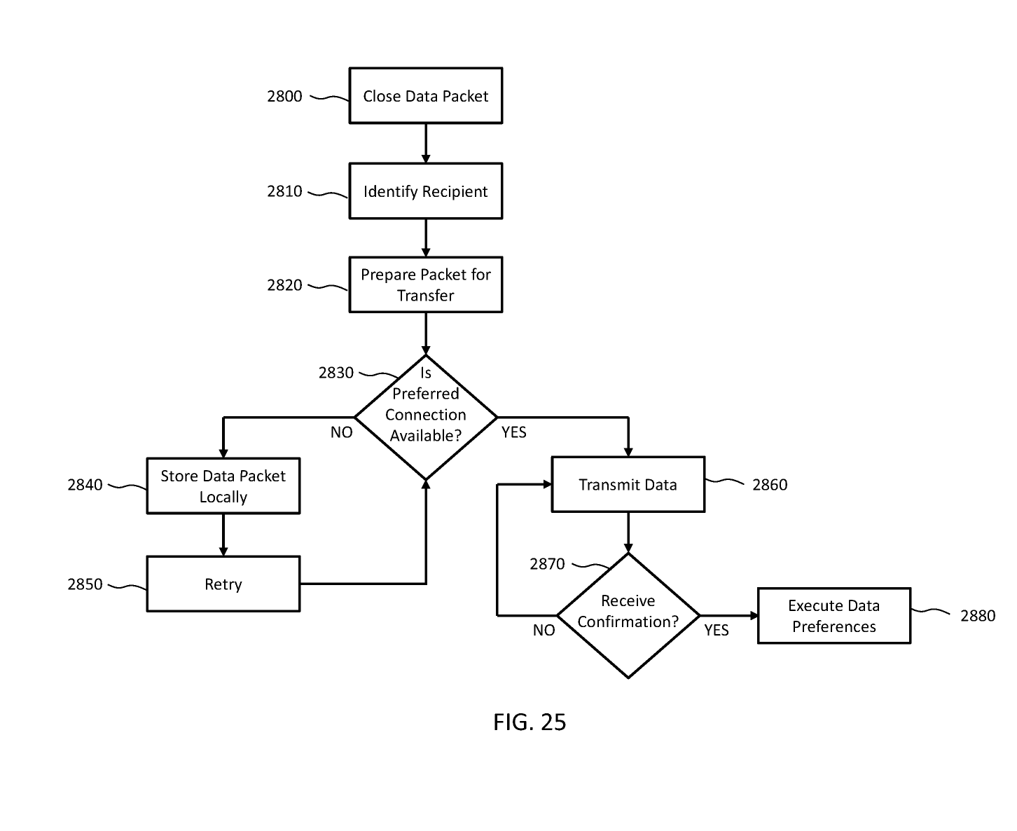

FIG. 25 depicts how data is transferred from the application to one or more of the cloud or remote server. The application will close the data packet 2800, identify the recipient of the data packet 2810, and then prepare the packet for transfer 2820. When the preferred network is available 2830, the application will transmit data 2860 to one or more of the cloud or remote server. When the data has been received by one of the cloud or remote server, the application will receive confirmation 2870 that the data has been successfully transmitted. After the data is received, one of the cloud or remote server will execute data preferences 2880. If no preferred network is available, the data packet will be stored locally 2840 on the smart device running the application. The application can retry transmitting 2850 the assembled packet when the next preferred network is available. If a preferred network is available, the application will transmit data 2860 to one or more of the cloud or remote server.

### Usage Control Mechanisms

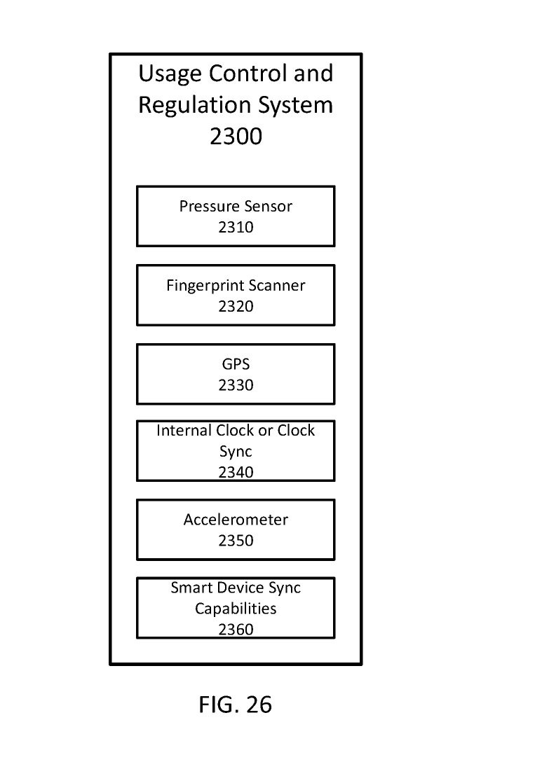

Referring to FIG. 26, a vaporization unit may include one or more usage control and regulation systems 2300 and methods in any of its embodiments. The vaporization unit control and regulation systems may comprise one or more of the following: pressure sensor 2310 to complete or activate power circuit; fingerprint scanner 2320; GPS 2330 usage control; internal clock or clock sync 2340 for time of day control; accelerometer 2350; and ability to sync with smart devices 2360.

In further discussion of FIG. 26, the fingerprint scanner 2320 may be one of continuous or intermittent. A continuous fingerprint scanner will allow the vaporization unit to work only when the registered user is holding the unit. The continuous fingerprint scanner may be combined with a pressure sensor. An intermittent fingerprint scanner may only scan for the registered user fingerprint every set period of time (such as a few seconds or minutes) or at a random interval unknown to the user (to prevent ‘cheating’). The fingerprint scanner 2320 may or may not provide feedback to the user. Feedback to the user may be one of haptic, visual, or audio. Feedback may be visible on the unit itself and/or on an associated smart device.

The vaporization unit may include GPS 2330, accelerometer 2350, and internal clock 2340, or ability to sync with a smart device 2360 for the associated information. The vaporization unit may be programmed to only work at certain times of the day and/or in only certain locations as a method of dosage and usage control. The GPS 2330 and accelerometer 2350 may also serve to prevent use while driving.

Further methods of dosage control may comprise one or more of the following: blood testing, saliva testing, and breath testing. The user's finger may be pricked at intervals to determine how much of the drug is in the user's blood and to calculate how much more the user is allowed to partake. The user's saliva and/or breath may be analyzed at intervals (such as every puff or every few puffs) to determine concentration of the drug in the user's system. Algorithms may be employed to calculate when the user will have had their full dosage. When the user has reached their dosage limit the unit will no longer operate until the next dosage is allowed.

The vaporization unit may include the ability to sync with smart devices. The vaporization unit may share information with the smart device(s). The vaporization unit may also only operate if a registered user's smart device has been activated, is in proximity, and/or the user has confirmed their identity via an application or other security measure on the smart device, such as a PIN code, security questions, or a password. The vaporization unit may also confirm user identity via voice, fingerprint, facial, eye, iris, or dental or other video/image feature recognition scans. Multiple user identification methods may be implemented.

In one embodiment, the vaporization unit processor 400 is configured to monitor the user's consumption data and store the consumption data in the vaporization unit memory 630, and disable the vaporization unit based on the consumption data, i.e. if the consumption data indicates that a pre-determined or pre-programmed amount has been consumed by the user, the vaporization unit shuts down and becomes unusable until the next pre-determined dosage allowance is due.

In an alternate embodiment, the unit that contains the product to be consumed or administered can be configured to contain and administer additional inhalable products or medicines besides cannabis concentrates. Examples include but are not limited to, inhaled forms of opioid narcotic pain medications, anti-depressant medication, anti-anxiety medication, or any medication that can be inhaled that requires regulated control and accountability by the user. In this particular embodiment, all unit functionality previously disclosed can be incorporated into the unit, and vaporization may or may not be required.

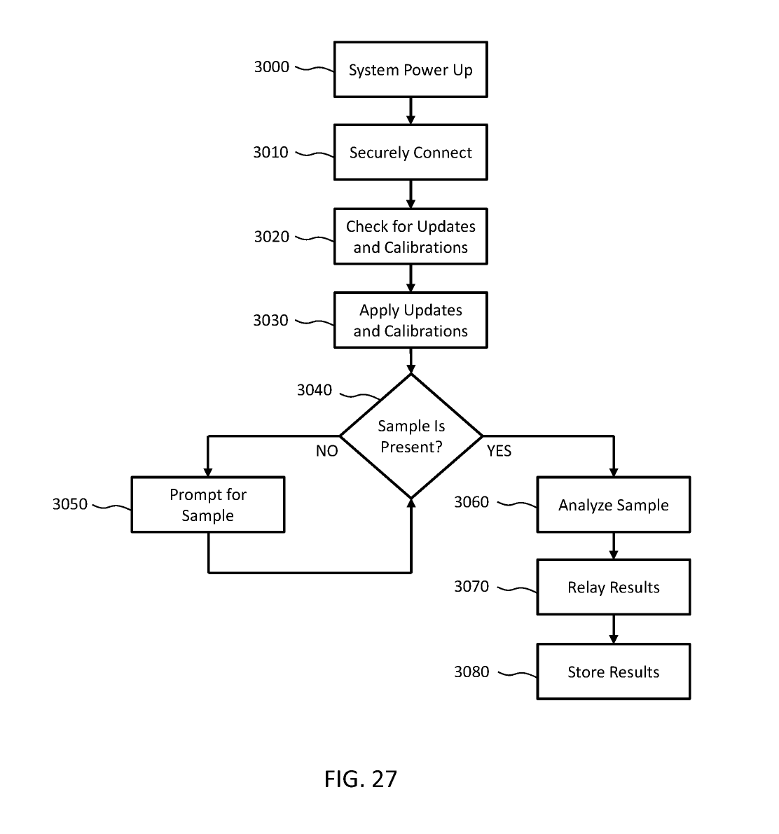

FIG. 27 depicts how a bio sample analysis is initiated and transferred from the application to one or more of the cloud or remote server. The system will power up 3000, identifies the unit or the smart application and securely connects 3010, and then checks for updates, calibration options, or other applicable settings 3020. Once the unit is connected and applicable updates, calibrations, and other settings have been applied 3030 then it will be determined whether or not the sample is present 3040. When the sample is not present the application will prompt for a sample 3050. When data has been received that the sample is present then the application will analyze the sample 3060. Once the sample analysis is complete the results will be relayed 3070 and stored 3080 either within the unit or in a place accessible to the unit. If a preferred network is available, the application will store data 3080 to one or more of the cloud or remote server. If no preferred network is available, the data will be stored locally 3080 on the smart device running the application.

### Part 3 —Product Recipe Concept and Product Marking

Cannabis Concentrates

Cannabis concentrates (hereinafter “concentrates”) are products extracted from the cannabis plant using a variety of extraction methods. They may be comprised of either cannabinoids or terpenes, or both. Typically, concentrates can have anywhere from 60-90% delta-9-tetrahydrocannabinol (THC) content and, regarding THC specifically, are considered among the most potent THC-content forms of cannabis available to medical cannabis users. In addition to THC, concentrates can contain other medically beneficial compounds discussed in further embodiments. Depending on the extraction process used, cannabis concentrates can be ingested, vaporized, or smoked. The effectiveness of a cannabis concentrate is determined by the quality of the cannabis used to create it, as well as the accuracy of adhering to a specific extraction process or “recipe”.

Cannabis concentrates are produced using various methods, many of which employ the use of harmful and dangerous chemical solvents. One common method, known as BHO Extraction (Butane Honey Oil Extraction) has become a recent focus of municipal entities, such as local police departments, and federal agencies such as the Drug Enforcement Administration (DEA), due to the hazards that are increasing right along with the increased use of medical marijuana.

Injuries, explosion, and fire incidents resulting from attempts to manufacture cannabis concentrates in homes have been reported throughout the United States and other countries. As example, publicly available information shows that there were two home explosions in July 2013, in Michigan, which allows medical marijuana use with proper credentials. In December 2013 a Virginia man suffered third degree burns in an explosion while attempting to make BHO. Shortly after the state of Colorado legalized recreational marijuana use, a similar explosion occurred in Colorado Springs in early March 2014.

Types of Cannabis Concentrates

The term “concentrate” is now widely used in the cannabis industry, and many forms of cannabis concentrates exist. Examples include a wax that is smoked or vaporized, a tincture that is swallowed or placed under the tongue, or essential oils that can be smoked, vaporized, or added to hard-candy, cookies, butter, or almost any type of edible product. Further descriptions of these types of cannabis concentrates include butane honey oil (“BHO”; cannabis compounds are extracted with butane then purged of the butane), hash or hashish (a solid, typically extracted using ethyl alcohol or ice water), tinctures (a liquid, with cannabis compounds extracted using ethyl alcohol), CO2 oil (cannabis compounds are extracted using pressurized carbon dioxide), and Rick Simpson Oil (“RSO”, cannabis is soaked in pure naphtha or isopropyl alcohol to extract cannabis compounds, then the solvent is fully evaporated leaving behind a tar-like liquid that can be administered orally or applied directly to the skin). With most all cannabis concentrates the end result product can contain either high or low amounts of the various beneficial cannabis compounds depending on the sub-species (sativa, indica, ruderalis) or growing method used, with examples including the aforementioned THC (a psycho-active component), and Cannabidiol (“CBD”, which is generally non-psychoactive and has been known to reduce pain and provide a host of other benefits).

One primary difference between using cannabis concentrates and smoking traditional-type cannabis is potency. Concentrates are as the name implies: concentrated. For perspective, cannabis concentrates are a compound derived from the original cannabis plant, similar to fruit juice concentrates being a compound derived from the original fruit. To create a concentrate from the cannabis plant one of the extraction methods previously mentioned in this specification, such as CO2 extraction, is employed to strip the cannabis of the various cannabinoids and terpenes and isolate them from the actual plant fibers, chlorophyll, and other plant material. This dramatically raises the potency of the beneficial cannabis components, thereby making the extracted concentrate more effective for use by medical patients with serious health issues.

The production of cannabis concentrates is safe when proper, controlled methods are used. Like many scientific processes, the proper methods for making cannabis concentrates are complicated, require flawless execution in a lab setting, and need to be exact in order to produce a high-quality concentrate. If inexact techniques are used, residual solvents can remain in the end-result product, and disasters can occur, such as the explosion examples mentioned previously in this disclosure. Concentrates that contain the residual solvents can be harmful or fatal to users of the product. Cannabis concentrates do exist that are produced without solvents, which safeguards against an accidental solvent contaminant, but concentrates made with a solvent-less process are typically lower potency than, say, CO2 extraction-concentrates and other concentrates made with solvent extraction methods.

The current state of the art generally concurs that the “supercritical CO2 extraction” method allows for substantial benefits over the other options currently known and mentioned above. When the solvent (as CO2) is forced through the cannabis plant matter at high pressure, it is able to separate the components accurately with precision, allowing the isolation of the purest essence of the desired compounds. CO2 has the benefit of being a pure, naturally occurring compound, which experts agree is a significant advantage over other solvent types used for cannabis extraction. The potency, effectiveness, and end-result ingredient of a cannabis concentrate is determined by the quality of the cannabis used to create it, the specific strain of cannabis used, as well as the accuracy used in the concentrate extraction process. Cannabis concentrates are able to be ingested, vaporized or smoked depending on the extraction process used.

Increased use of medical marijuana, as well as increased legal recreational use in certain U.S. states, will cause cannabis products to see an increase in production, especially with concentrates. The need for a safe, consistent, system and method is required for making and dispensing cannabis products to ensure manufacturing safety, dispensary accountability, user accountability, user age verification, dosage control, and product distribution and consistency.

While methods for making cannabis concentrates are indeed known in the art, a method or methods for maintaining accurate content consistency and traceability are not known in the art. Until recently the making of cannabis concentrates (hereinafter “concentrates”) has been illegal, and generally concentrates were made in uncontrolled and un-regulated “home” labs, with potential for human and structural harm on many levels, to include explosions, fires, and poisoning of a user, as a few examples. Now, with medical marijuana usage gaining more acceptance in the medical community, and legal recreational marijuana use gaining traction in U.S. States such as Washington and Colorado, the new cannabis concentrate industry must become better regulated and safer, or it could prove to be a disadvantage to the current and future legalization of medical and recreational marijuana.

Continuing with an embodiment of the present invention, a formula or “recipe book” contains specific concentrate formulas that produce an extract containing at least one of Tetrahydrocannabinol (THC), Tetrahydrocannabinolic Acid (THC-A), Cannabinol (CBN), Cannabigerol (CBG), Cannabichromene (CBC), Cannabidiol (CBD), Cannabidiolic Acid (CBD-A), Linalool, Caryophyllene, Myrcene, Limonene, Humulene, Pinene, and Carboxylic Acids, among other possible compounds. For purposes of this embodiment, these compounds will be referred to as the desired end-result compounds, or end-result compounds. Typically the raw, unprocessed cannabis plant material is first dried and ground or shredded to a specific particulate size, or, more generally, the cannabis plant material is simply “ground up”, achieving a result similar to what happens when coffee beans are ground up for brewing coffee. In the present embodiment, the ground, pulverized, or otherwise shredded cannabis plant material is subjected to a CO2 extraction process, whereby some or all of the desired cannabis compounds mentioned above are extracted by forcing supercritical carbon dioxide through the cannabis plant material using controlled conditions with a temperature range of approximately 68° F. to 180° F. and a pressure range of approximately 75 bar to 500 bar. An entraining agent or “vehicle” is added to the CO2 to help carry it along through the process and move it through the cannabis plant material. Typically the entraining agent comprises one or more from the following group: water, butane, propane, and ethanol. During the initial process an adsorbent is added to the cannabis plant material to allow the desired end-result compound(s) to come to the surface of said material so that they may be removed at some point in the process. The adsorbent may comprise activated carbons, bentonites, diatomaceous earth, silica gel, or mixtures thereof, or, more generally, any adsorbent commonly known in the art. The extraction process may be repeated more than once to further refine the concentration.

Cannabis contains cannabinoids and terpenoids. Cannabinoids are a class of diverse chemical compounds that act on cannabinoid receptors on cells that repress neurotransmitter release in the brain. There are at least 85 different cannabinoids isolated from cannabis, exhibiting varied effects. Terpenoids, more broadly known as terpenes, are responsible for the aromas and colors in cannabis. Similar to cannabinoids, terpenoids have been shown to have numerous beneficial health properties. Each cannabinoid and terpenoid has a different boiling point.

A vaporizer with temperature controls allows the user to control the precise temperature used to heat the cannabis, and therefore which cannabinoids and terpenoids are released into the vapor. Because all cannabinoids and terpenoids have different boiling points, the same cannabis batch heated to two different temperatures will release different compounds. The lower the temperature used to vaporize, the fewer the compounds will have reached their boiling points thus fewer compounds will be released.

Below is a list of some of the known cannabinoids and terpenoids, their boiling points, and an overview of their medicinal qualities as described by Steep Hill Labs, INC., titled Cannabinoid and Terpenoid Reference Guide, Copyright© 2014.

Δ9-Tetrahydrocannabinol (THC)

### Formula: C21H30O2

Molecular Mass: 314.45 g/mol

### Boiling Point: 157° C. (315° F.)

Δ9-Tetrahydrocannabinol (commonly referred to as “Δ9-THC,” “D9-THC,” “d9-THC” or simply “THC”) is a neutral cannabinoid, well known for being strongly psychoactive. Of all the scientific discoveries that have been made about THC, probably the single most important was how THC enabled scientists to discover the existence of the Endocannabinoid system in vertebrate animals (including humans): a critical part of physiology that, up until then, was unknown. THC has been shown to be effective in the treatment of a variety of ailments and disorders including pain, tumors, nausea and ADHD.

Δ1-Tetrahydrocannabinolic Acid (THC-A)

### Formula: C22H30O4

Molecular Mass: 358.4733 g/mol

### Boiling Point: 105° C. (220° F.)

Tetrahydrocannabinolic acid, like other acid cannabinoids, is not psychoactive. THC-A is strongly anti-inflammatory, encourages appetite, is anti-tumor, combats insomnia, and is antispasmodic. THC-A is the most abundant terpenoid (and Cannabinoid) in the vast majority of Cannabis grown in the U.S., reaching levels over 30% of dry weight for flowers from female, unpollinated plants (sensomilla). Many “high THC” strains, when grown and harvested optimally, produce about 15% THC-A by dry weight, though this can vary widely.

Cannabinol (CBN)

### Formula: C21H26O2

Molecular Mass: 310.1933 g/mol

### Boiling Point: 185° C. (365° F.)

Cannabinol is an oxidation product of THC. It normally forms when THC is exposed to oxygen and heat. A high level of CBN often reflects cannabis that is old or has been exposed to significant heat. CBN is known to be very slightly psychoactive and more strongly sedative than other known Cannabinoids. As such, samples with significant CBN (approaching 1% by weight) can be useful to treat insomnia. CBN is also somewhat effective as an anti-emetic and anticonvulsant.

Cannabigerol (CBG)

### Formula: C21H32O2

Molecular Mass: 314.2246 g/mol

### Boiling Point Not Available

Cannabigerol is non psychoactive, and has been shown to stimulate the growth of new brain cells, including in the elderly; it should be noted that genuinely neurogenic compounds are extremely rare. CBG also stimulates bone growth, is antibacterial and anti-tumor, and combats insomnia.

Cannabichromene (CBC)

### Formula: C21H30O2

Molecular Mass: 314.2246 g/mol

### Boiling Point: 220° C. (428° F.)

Cannabichromene is also non psychoactive, and has been shown to be about ten times more effective than CBD in treating anxiety and stress. It also displays efficiency in treating inflammation, pain relief and is both anti-viral and anti-tumor. CBC has been shown to stimulate the growth of bone tissue.

Cannabidiol (CBD)

### Formula: C21H30O2

Molecular Mass: 314.2246 g/mol

### Boiling Point: 180° C. (356° F.)

Cannabidiol is “non-psychoactive” (in that it does not produce the euphoria, time dilation, or anxiety normally produced by THC) and has been shown to be extremely valuable in the treatment of seizure disorders such as MS and Epilepsy. Its lack of psychoactivity makes it ideal in treating children, the elderly and patients that prefer to remain clear headed and focused. CBD is often as effective as THC in the management of pain and tumors. CBD also lowers blood sugar, and has been used in the treatment of Diabetes. CBD has a calming effect, and is useful in the treatment of stress related disorders and sleep loss.

Cannabidiolic Acid (CBD-A)

### Formula: C22H30O4

Molecular Mass: 358.2144 g/mol

### Ideal Decarboxylate Temperature: 120+° C. (248° F.)

Until recently, Cannabidiolic acid was much more commonly found in higher concentrations in Ruderalis than in Cannabis. In the last few years, strains of Cannabis have been hybridized that produce more CBDA than THCA, including “Cannatonic-C6” and “ACDC.” CBDA has been shown to be both anti-inflammatory and anti-tumor.

Linalool

### Formula: C10H18O

Molecular Mass: 154.1358 g/mol

### Boiling Point: 198° C. (388° F.)

Vapor Pressure: 0.17 mmHg (25° C.)
Linalool is simple terpene alcohol, probably best known for the pleasant floral odor it gives to lavender plants. It is also known as β-linalool, licareol and linalyl alcohol. Linalool has been isolated in several hundred different plants including lavenders, citrus, laurels, birch, coriander and rosewood. Linalool has been used for several thousands of years as a sleep aid. Linalool is a critical precursor in the formation of Vitamin E. It has been used in the treatment of both psychosis and anxiety, and as an anti-epileptic agent. It also grants relief from pain and has been used as an analgesic. Its vapors have been shown to be an effective insecticide against fruit flies, fleas, and cockroaches.

β-Caryophyllene

### Formula: C15H24

Molecular Mass: 204.1878 g/mol

### Boiling Point: 160° C. (320° F.)

Vapor Pressure: 0.01 mmHg (25° C.)
Beta-caryophyllene is a sesquiterpene found in many plants including That basils, cloves and black pepper, and has a rich spicy odor. Research has shown that β-Caryophyllene has affinity for the CB2 endocannabinoid receptor. β-Caryophyllene is known to be anti-septic, anti-bacterial, antifungal, anti-tumor and anti-inflammatory.

β-Myrcene

### Formula: C10H16

Molecular Mass: 136.1252 g/mol

### Boiling Point: 168° C. (334° F.)

Vapor Pressure: 7.00 mmHg (20° C.)
β-Myrcene is a monoterpene, and for a wide variety of reasons, one of the most important terpenes. It is a precursor in the formation of other terpenes, as well. β-Myrcene is found fresh mango fruit, hops, bay leaves, eucalyptus, lemongrass and many other plants. β-Myrcene is known to be anti-tumor, anti-inflammatory, and used in the treatment of spasms. It is also used to treat insomnia, and pain. It also has some very special properties, including lowering the resistance across the blood to brain barrier, allowing itself and many other chemicals to cross the barrier easier and more quickly. In the case of cannabinoids, like THC, it allows it to take effect more quickly. More uniquely still, β-Myrcene has been shown to increase the maximum saturation level of the CB1 receptor, allowing for a greater maximum psychoactive effect. For most people, the consumption of a fresh mango, 45 minutes before inhaling cannabis, will result in a faster onset of psycho activity and greater intensity. β-Myrcene can be used in this same manner to improve uptake with a wide variety of chemical compounds.

D-Limonene

### Formula: C10H16

Molecular Mass: 136.1252 g/mol

### Boiling Point: 176° C. (349° F.)

Vapor Pressure: 1.50 mmHg (25° C.)
D-limonene is a cyclic terpene of major importance with a strong citrus odor and bitter taste. D-limonene was primarily used in medicine, food and perfume until a couple of decades ago, when it became better known as the main active ingredient in citrus cleaner. It has very low toxicity, and humans are rarely ever allergic to it. Medicinally, Limonene is best known for treating gastric reflux and as an anti-fungal agent. Its ability to permeate proteins makes it ideal for treating toenail fungus. Limonene is also useful in treating depression and anxiety. Limonene also assists in the absorption of other terpenoids and chemicals through the skin, mucous membranes and digestive tract. It's also been shown to be effective anti-tumor while at the same time being an immunostimulant. Limonene is one of two major compounds formed from α-Pinene.

Humulene

### Formula: C15H24

Molecular Mass: 204.1878 g/mol

### Boiling Point: 198° C. (388° F.)

Vapor Pressure: 0.01 mmHg (25° C.)
Humulene is a sesquiterpene also known as α-humulene and α-caryophyllene; an isomer of β-caryophyllene. Humulene is found in hops, cannabis sativa strains, and Vietnamese coriander, among others. Humulene gives beer its ‘floppy’ aroma. It is anti-tumor, anti-bacterial, anti-inflammatory, and anorectic (suppresses appetite). It has commonly been blended with β-caryophyllene and used as a major remedy for inflammation, and is well known to Chinese medicine.

α-Pinene

### Formula: C10H16

Molecular Mass: 136.1252 g/mol

### Boiling Point: 155° C. (311° F.)

### Vapor Pressure Not Available

α-Pinene is one of the principle monoterpenes, and is important physiologically in both plants and animals, and to the environment. α-Pinene tends to react with other chemicals, forming a variety of other terpenes (like D-Limonene) and other compounds. α-Pinene has been used for centuries as a bronchodilator in the treatment of asthma. α-Pinene is also anti-inflammatory. It's found in conifer trees, orange peels among others, and known for its sharp sweet odor. α-Pinene is a major constituent in turpentine.

It should be noted that different sub-species of the cannabis plant may be used to achieve optimal formulations of the desired end-result compounds. For example, Cannabis sativa generally produces the highest concentrations of THC, Cannabis indica generally produces the highest concentrations of CBD, and Cannabis ruderalis is generally used for industrial hemp production such as rope or fabric, but has been used to produce concentrates containing CBD.

It is important to consider that the end-result compound contains everything that was soluble in the original raw, unprocessed cannabis plant material. This can include pesticides, fertilizers, or other chemicals sprayed on the plant, or used in the soil, resulting in users of the end-result concentrate potentially ingesting dangerous doses of harmful toxins. The dispensary producing the concentrate should always take care to determine that the starting material was grown free of pesticides and harmful additives.

In the example of producing a concentrate high in tetrahydrocannabinol (THC) or cannabidiol (CBD), typically the initial process of CO2 extraction produces tetrahydrocannabidiolic acid (THC-A) and cannabidiolic acid (CBD-A), respectively. In this case, to further refine THC-A into THC, or CBD-A into CBD, the “acid forms” of the compounds are decarboxylated through an increase in temperature. The resulting decarboxylated primary compound is dissolved in the CO2 extracting agent, and is further treated by using a high-pressure vessel containing a catalyst for an anellation chemical reaction, whereby cannabidiol is reacted to give tetrahydrocannabinol; and the portion containing tetrahydrocannabinol is separated at pressure and temperature conditions subcricital for CO2. Alternately, the decarboxylated primary compound cannabidiol is separated through column chromatography on silica gel, or high-pressure liquid chromatography.

Winterization:

Supercritical fluid extraction or “CO2 Extraction”—while efficient and safer than classical solvent extraction systems—suffers from a lack of extraction selectivity. As a result, many compounds are co-extracted along with the target compounds. This means that any extraction performed with the CO2 extraction procedure needs to undergo post-production techniques in order to refine the extract. In the case of supercritical fluid extraction of cannabinoids, saponins, paraffinic compounds and lipids are co-extracted with the target cannabinoids. One known in the art post-production technique is called “winterization”.

The process of winterization involves dissolving the extract in a solvent, which serves as either a further extraction menstruum, is used to precipitate out undesired compounds, or some combination of both. The most common methods involve using either n-hexane or ethanol as a diluent. In these cases, the organic solvents are an extraction menstruum for the target cannabinoids. The dilute extract is then brought to freezing temperatures (^{˜}−10° C.) for 24-48 hrs. Compounds with a high boiling point (>350° C.) will pass preferentially into a solid state (precipitation), while compounds with a lower boiling point will dissolve preferentially into the diluent (n-hexane or ethanol) and become what is known as the supernatant.

In addition to this, special buffers (composed of aqueous mixtures of neutral salts, such as ammonium nitrate or sodium sulfate) can be used to accelerate this process. Neutral salts provide an ionic environment which will further facilitate the precipitation of non-polar compounds from an organic solution.

The materials needed are: Pyrex dish with lid, analytical balance, 500 mL graduated beaker, 500 mL graduated cylinder, ethanol USP, Buchner apparatus, 64 μm pore size filer, anhydrous sodium sulfate, roto evaporator with pressure gauge, tongs, spatulas, a container or containers for waste, a container or containers for oil reclamation, parafilm, extract, freezer, agitator, ice chest, white petrolatum, funnel, vacuum pump, and acetone. Additional suggested materials comprise: gloves, eye protection, lab coat, and well ventilated room (preferably a NIOSH certified respirator).

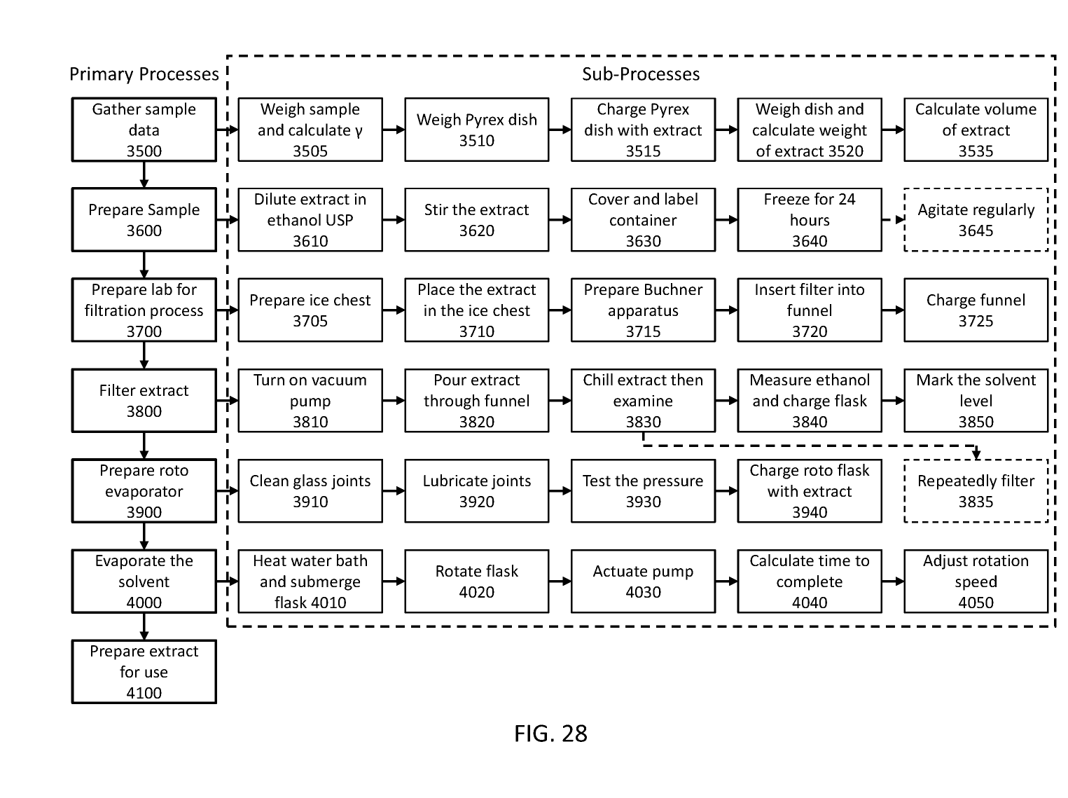

Referring to FIG. 28 the procedure is as follows:

Gather sample data 3500.

Take one aliquot of the sample and weigh it to determine its specific gravity (γ) 3505. Specific gravity is defined as weight (in grams) per cubic centimeter (milliliters) at room temperature (23° C.).

Weigh the Pyrex dish and take note of its weight 3510.

Charge the dish with the freshly prepared extract 3515.

Weight the dish with the extract and subtract the weight of the dish 3520. Based on the specific gravity of the extract, determine its volume 3525. This step will minimize the need for unnecessary transfers and waste.

Prepare sample 3600.

Dilute the extract in ethanol USP in a 1:1.5 ratio, extract to ethanol, respectively 3610.

Stir the extract at room temperature gently with a spatula 3620.

Cover the container, label it appropriately 3630 and place it in the freezer for 24 hours 3640.

If at all possible, the extract should be agitated 3645, by gentle rocking, every few hours to ensure that the precipitant is not completely congealing—it should be the consistency of a slurry.

After 24 hours have elapsed, prepare the lab for the filtration process 3700.

Prepare an ice chest 3705 to store the extract and all reagents during the filtration process. This is a critical step, as the paraffins in the precipitant will begin to melt and dissolve back into the solvent as they warm up to room temperature.

Place the extract in the ice chest 3710.

Prepare the Buchner apparatus 3715 by lubricating the opening of the receiving flask with white petrolatum (Vaseline). Attach the filter and rotate it to ensure that a tight seal is produced.

Insert the filter into the funnel 3720 then charge the funnel 3725 with enough anhydrous sodium sulfate to fill the funnel to approximately 1 inch in height.

Process the extract 3800.

Turn on the vacuum pump 3810 then gently pour the extract through the funnel 3820 being sure that the pressure gauge shows there to be a measurable change in pressure. If the pressure still reads as atmospheric pressure, the seal may be broken or the extract may not be evenly distributed in the funnel. Do not rinse the contents of the funnel after the extract has passed through. Save the contents of the funnel for the reclamation cycle.

Chill the extract for an hour then examine 3830 it for any signs of solids precipitating out of solution. If white or yellow crystals appear at the bottom of the solution, it means that too much water was in the extract for the anhydrous sodium sulfate bed to react properly and sodium sulfate crystals are passing through the filter. To resolve this, repeatedly filter 3835 the solution through fresh anhydrous sodium sulfate until no more crystals appear.

Measure out 10 mL of ethanol and charge the receiving flask 3840 of the roto evaporator with it.

Mark the solvent level 3850 on the receiving flask itself. This will be used to measure the flow rate during the evaporation procedure.

Prepare the roto evaporator for use 3900 by cleaning all ground glass joints 3910 with acetone. To lubricate the joints 3920, place a small dab of white petrolatum at the top of the male side of the joint. Rotate the fixture to ensure that the petrolatum is distributed around the joint as a small ring.

Test the pressure 3930 by attaching a pressure gauge and actuating the diaphragm pump.

Turn off the diaphragm pump. If no pressure change occurs after 30 seconds, there is a sufficient seal will occur. Release the pressure by stating the spigot located on the condenser.

Charge the round roto evaporator flask with the filtered extract 3940.

Evaporate the solvent 4000.

Bring the water bath in the ice chest to 40° C. then submerge the flask in the bath 4010. Once signs of volatilization occur within the flask, rotate the flask at 60 RPMs 4020. Different extracts will require different rotation rates, however. It is important that the extract be uniformly distrusted on the upper hemisphere of the flash as a thin film this will facilitate optimal evaporation of volatile solvents.

Actuate the pump 4030. The flow rate should be approximately 10 mL/min. If not adjust the settings to best facilitate the best possible approximation of that flow rate.

Calculate the estimated time for the extract to be completely free of solvent 4040. If the actual time is different than the estimated time, the setting can be adjusted to a faster rotation, such as 80 RPMs, and 50° C. According to Roult's Law, the volatility of organic solvents is modulated by the presence of non-volatile compounds. Therefore, the temperature may be increased to complete the evaporation when the volume level of the extract approaches the theoretical yield.

Once the evaporation is complete, prepare the extract for commercial use 4100.

### Waste Reclamation:

Post production of supercritical fluid extracts produces a significant amount of waste product. Essential resources from waste product can be reclaimed as product efficiently through standard chemical procedures, such as distillation and extraction. Sources of reclaimable waste comprise: transferring of samples from one vessel to another, sample remaining on desiccating surfaces or filters, ethanol used for winterization, and waste alcohol from rotary evaporation. Sources of non-reclaimable waste comprise: samples spilled on floors and countertops and sample material contaminates with significant amounts of water, dust, or that has been left in the open air for more than an hour.

Increasing the output of production efforts, therefore, entails a two-fold approach: samples need to be handled according to good laboratory practices. All samples should be exposed to open air for no more than an hour, sources of dust, water, or any foreign material should be curtailed by keeping sample material covered and pouring samples carefully. Additionally, sources of waste need to be properly identified and stored in a covered container for future reclamation of valuable materials.

Reclamation:

Reclaimable waste is composed of both solid and liquid forms. Solid and liquid forms of reclaimable waste should be stored in separate labeled and covered containers. All filters and desiccant material used in post-production will fall into the solids container for future solids extraction. Solids will be extracted using a Soxhlet apparatus.

Reclaiming films of sample left in vessels during sample transfers involves washing the beaker with hot ethanol. Since the nature of this section is about minimizing the usage of resources, waste alcohol may be used for this purpose. To streamline workflows, used beakers may be covered with watch glasses or parafilm and put to the side for later cleanup.

Solids Extraction:

The materials needed are as follows: ethanol or n-hexane, a 1 liter round bottom flask, an Alihn condenser, a 500 mL Soxhlet extractor, a ring stand with clamps, an oil bath and heating mantle, cotton balls, water and water pump, solid reclaimable waste, and siphoning tube. Additional materials may comprise a lab coat, gloves, respirator, and eye protection.

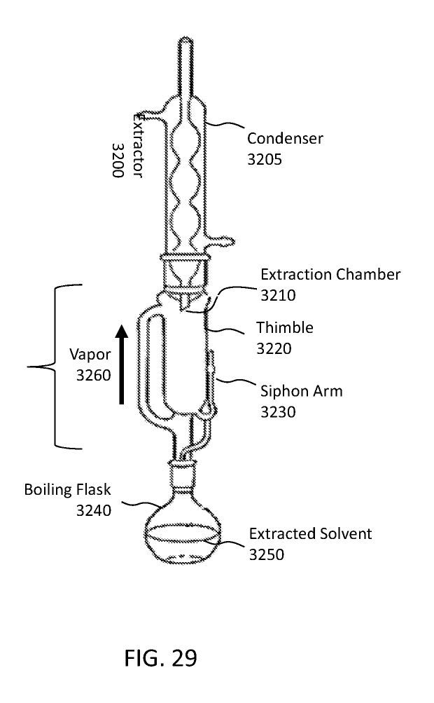

A Soxhlet extractor, depicted in FIG. 29, consists of three parts: a condenser 3305, an extraction chamber 3210, and a boiling flask 3240. Solid materials are placed in the extractor 3200. A volatile solvent 3250 is heated in the boiling flask 3240 with an oil bath. It volatilizes as vapor through the sidearm of the extractor 3200, condenses in the condenser 3205, then fills the extraction chamber 3210. Once the extraction chamber 3210 reaches a fixed volume, it flushed back into the boiling flask 3240, where the extract will continuously concentrate while the solvent 3250 circulates.

The advantage to using such an apparatus is that a fixed amount of solvent may be used to extract oils from solid reclaimable waste. A full cycle may take up to 24 hours, so this apparatus may run continuously in the background while other tasks are being performed in a lab. However, occasionally, the Soxhlet apparatus may become clogged. Troubleshoot clogging is referred to further in the specification.

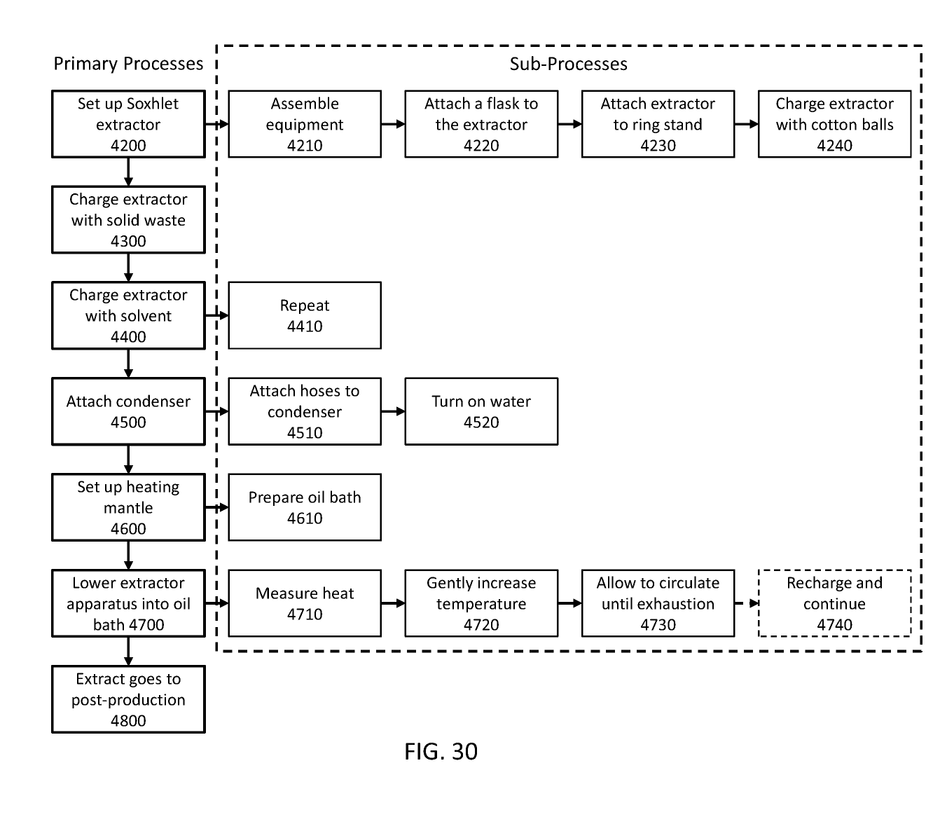

The solid waste reclamation process is depicted in FIG. 30 and described below.

To set up the Soxhlet extractor 4200, assemble all the required equipment 4210.

Attach a clean round bottom flask to the Soxhlet extractor 4220 and clamp the joint in place.

Attach the Soxhlet extractor to the ring stand 4230, leaving room for a heating mantle and oil bath.

Charge the Soxhlet extractor with a few cotton balls 4240, so as to fill the bottom of the extractor.

Charge the extractor with solid reclaimable waste 4300 until its volume just reaches the bubble on the siphon arm.

Charge the extractor with the chosen solvent 4400 slowly and evenly until the contents of the extractor flushes into the round bottom flask. Repeat 4410 this one additional time, such that twice as much solvent is needed to flush the apparatus once.

Attach the condenser 4500.

Attach hoses to the condenser 4510 and turn water on 4520 to ˜0° C.

Set up heating mantle 4600 and oil bath 4610 then gently lower the whole apparatus into the bath 4700. In addition, liquid reclaimable waste may be used as either part or all of the extraction menstruum.

Using a thermometer to measure the heat 4710, gently increase the temperature of the oil bath 4720 until it reaches ˜+5° C.> the boiling point of the selected solvent. Example EtOH BP: 78.8° C.; n-hexane BP: 69° C.

Allow the circulation to proceed until exhaustion 4730. This will be evident when the solvent in the siphoning tube is clear.

The Soxhlet extractor can then be recharged 4740; the extract collected in the boiling flask will continue to concentrate as additional extractions are run with it.

After all waste is reclaimed, the resulting extract undergoes the ordinary winterization and post production processes 4800.

Liquid Waste:

Liquid reclaimable waste not being used as a part of solids extraction, and that contains a significant amount of resin, can undergo the ordinary winterization and post production processes. Liquid waste may be reused as an extraction or winterization solvent, if it undergoes fractional distillation.

To recover solvent produced as a byproduct of rotary evaporation, a fractional distillation is necessary to separate its constituents in relatively pure fractions.

Fractional distillation works along the same principal as a simple distillation but it utilizes a fractionating column. Simple distillations are more than adequate for separating two or more components with boiling points >20° C. apart from each other. As the temperature of a mixture increases, the components of the mixture will cycle through vapor and liquid states. Boiling a 50/50 mixture of alcohol at 80° C. might produce a vapor containing ˜60% ethanol. Repeated distillations will purify the ethanol further.

For separating compounds that have similar boiling points, or when a high purity distillate is required, a fractionating column is employed. A fractionating column contains more surface area than does a simple distillation head alone. The greater the surface area, the more frequently the mixture will cycle through gaseous and liquid states. As such, all compounds are said to be in a liquid/gas equilibrium; however, the compound of the lowest boiling point will favor the gas phase. Ergo, with increased cycles, comes an increased purity of the most volatile constituent. In this manner, the solvents can be separated one component at a time by boiling point.

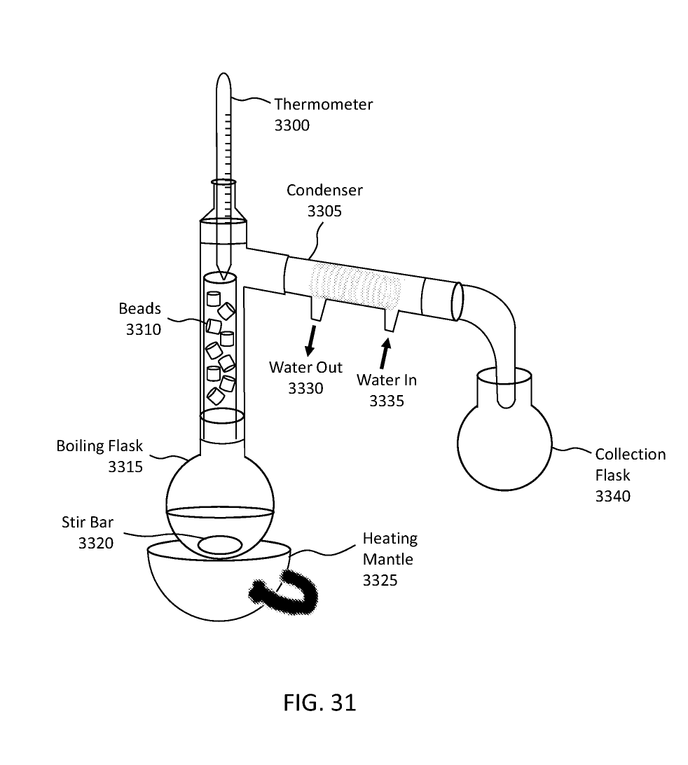

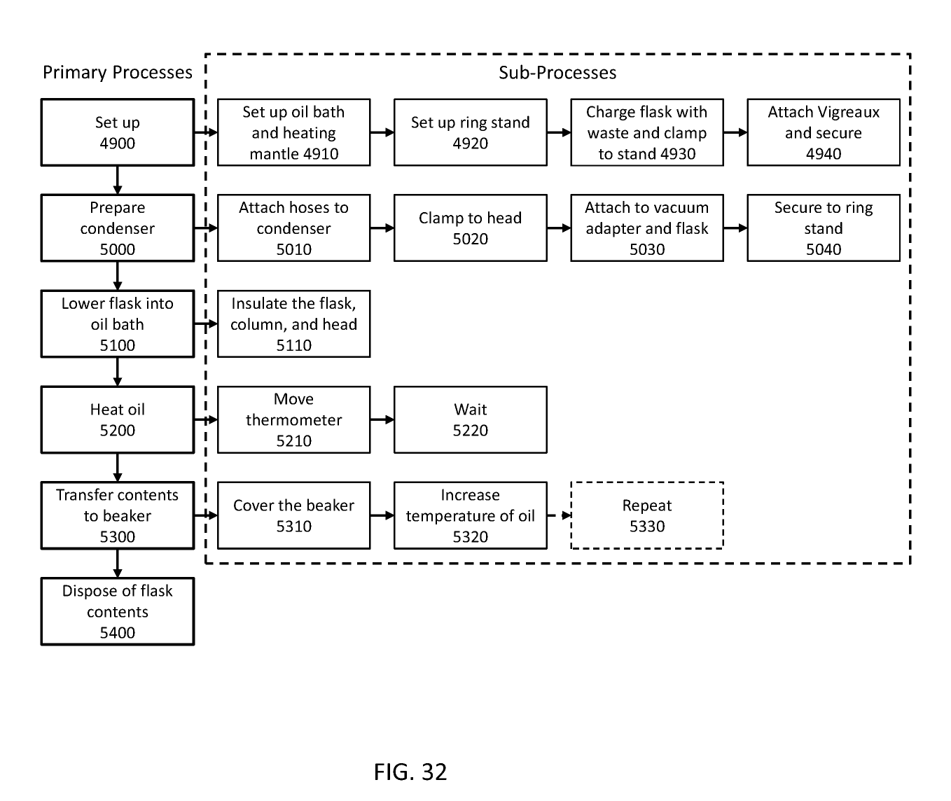

FIGS. 31 and 32 depict the liquid waste extraction process.

The materials needed comprise: 300 mm Vigreaux column, distillation head with thermometer adapter, thermometer, two round bottom flasks, one Leibig condenser, water and water pump, two ring stands and clamps, clamps for securing glassware, oil bath and heating mantle, vacuum adapter, liquid reclaimable waste, hoses, beakers, and aluminum foil. Additional materials may comprise a lab coat, gloves, respirator, and eye protection.

Procedure:

Set up 4900.

Set up the oil bath and heating mantle 4910.

Set up ring stand 4920.

Charge flask of appropriate size with liquid reclaimable waste then clamp it securely to the ring stand 4930.

Attach the Vigreaux column and distillation head and use glassware clamps to secure all joints, then secure apparatus to the ring stand 4940.

Prepare condenser 5000.

Attach hoses to the condenser 5010 and attach it to the distillation head 5020 with joint clamp making sure to have the second end of the condenser supported with the second ring stand.

Attach the vacuum adapter and receiving flask to the condenser 5030 and secure 5040 with joint clamps and ring stand clamps.

Lower the boiling flask into the oil bath 5100.

Insulate the top hemisphere of the flask, the Vigreaux column and the distillation head 5110 with aluminum foil.

Using the thermometer, bring the oil to approximately +10° C. the boiling point of the lowest boiling point constituent of the mixture 5200.

Attach the thermometer back into the oil bath 5210 then wait 5220 for the distillate to move over to the receiving flask.

When the solvent stops flowing, the contents of the receiving flask should be transferred into a separate beaker 5300 and covered 5310. The temperature of the oil batch should then be gradually increased 5320 until more solvent flows through.

Repeat this process 5330 the temperature of the oil batch reaches 80° C. and all of the solvent has moved to the receiving flask.

Dispose of the contents of the boiling flask 5400.

In an ideal system, the process should only be recovering ethanol, n-hexane, and trace amounts of terpenes and water. Primarily, only two fractions will be recovered; one for n-hexane and one for ethanol. Both will contain some impurities still. If additional purity is desired, a triple distillation of each component will be necessary. Additionally, the ethanol fraction will have to be dried using anhydrous sodium sulfate or calcium chloride—the latter is preferable for this purpose only. To do this, make a slurry of desiccant 1 g/L, allow it to settle, then filter it with a Buchner apparatus. If crystals form in the ethanol, repeat this process.

Packing the Soxhlet:

The Soxhlet extractor will not run efficiently if there is significant channeling throughout the sample matrix. If channeling occurs while adding solvent to the extractor, try gently agitating the matrix while pouring to ensure that the matrix is evenly distributed throughout and packed uniformly. Additionally, in the case of cleaning sodium sulfate, one might try making a slurry of solvent and used sodium sulfate, then pouring the slurry into the extractor. This might prove messy, but a gentle hand will yield superior extraction efficiency.

Over packing of the extractor will also result in poor extraction efficiency, clogging or a general inability of the solvent to siphon correctly. If the matrix is packed too tightly, the solvent will not be able to flow throughout. Additionally, if the matrix volume reaches higher than the siphoning tube, not enough solvent can enter the extractor for a flush to occur.

Clogging usually occurs when too much of the matrix has passed into the siphoning tube. In this event, the whole apparatus may need to be powered down, cleaned and restarted. More often the not, however, there is a more streamlined method for handling this.

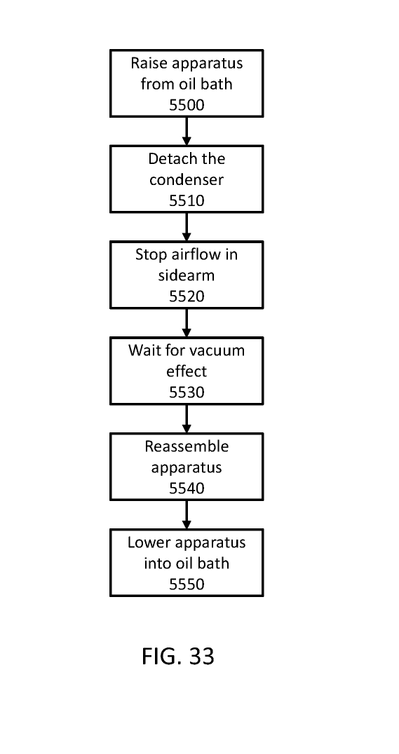

FIG. 33 depicts the procedure for cleaning the Soxhlet apparatus of clogs. The procedure is as follows:

Gently raise the whole apparatus out of the oil bath 5500.

Detach the condenser 5510.

Using the probe and rubber stopper, stop the airflow through the sidearm portion of the extractor 5520.

Assuming there is an airtight seal, as the contents of the boiling flask cools, a vacuum will be created which will suck most clogs through the siphoning tube. This may take a few moments to come in effect but it will be sudden 5530.

Reassemble the apparatus 5550 and lower it back into the oil bath 5560.

Boiling Flask Runs Dry:

The boiling flask may appear to run dry if the extract becomes too concentrated. Roult's Law states that the volatility of organic solvents is modulated by the presence of electrolytes or non-volatile solutes. Ergo, the more waxes and carbohydrates that build up in solution, the lower the vapor pressure will be. To overcome this, one may either empty the contents of the boiling flask and add new solvent to the extraction apparatus, or simply add more solvent to the extractor until the volume of solvent reaches its optimal solvent to non-volatile constituent ratio to start boiling again. Increasing the temperature of the oil bath to overcome this problem is unfavorable, as the risk of bumping the extract or burning it increases.

Additionally, the solvent may run dry if the apparatus is not assembled properly. One might try checking the glass joints of his round bottom flask and condenser. Also the water flow of temperature of the condenser might be set incorrectly.

### Terpenes

Terpenes are volatile molecules that evaporate easily and have noticeable, distinct, but varied aromas. As example, terpenes provide the basis for aromatherapy, which is a naturopathic alternative-healing method that relies on the odor of certain compounds. Terpenes are prevalent throughout the natural world, unlike THC, CBD, and other cannabinoids that exist nowhere else but marijuana. Produced by countless plant species, terpenes are prevalent in fruits, vegetables, herbs, spices, and other botanicals. Terpenes can be found throughout the human diet and the US Food and Drug Administration has deemed terpenes to be safe for human consumption.

Terpenes can be categorized into mono-terpenes, diterpenes and sesquiterpenes, depending on the number of repeating units of a five-carbon molecule called isoprene, which is the structural hallmark of all terpenoid compounds Of the approximately 20,000 terpenes that have been identified to date, approximately 200 different terpenes have been found in cannabis. However, only a small number of these cannabis terpenes possess the ability to be noticed by the typical sense of smell.

Cannabis terpenes have given marijuana a distinct survival benefit. Some cannabis terpenes are stimulating enough to repel insects and grazing animals, while other cannabis terpenes prevent fungus. To reduce plant disease and insect infestation, some organic cannabis growers spray the terpene-rich essential oils of plants such as neem and rosemary onto their crops. Terpenes also have health benefits for humans, according to a report entitled “Taming THC: potential cannabis synergy and phytocannabinoid-terpenoid entourage effects”, by Ethan B. Russo, copyright Nov. 19, 2010, and accepted into the British Journal of Pharmacology on Jan. 12, 2011, parts of which are included herein, as well as being disclosed as non-patent literature.

Following is a list of certain terpenes or terpenoids commonly found in cannabis, along with the known benefits of said terpenes.

Alpha-pinene is one of the most prevalent terpenes in the plant world and one commonly found in cannabis. Alpha is a bronchodilator potentially helpful for asthmatics. Alpha pinene also promotes alertness and memory retention by inhibiting the metabolic breakdown of acetylcholinesterase, a neurotransmitter in the brain that stimulates these cognitive effects.

Myrcene is another terpene present in numerous cannabis varietals, is a sedative, a muscle relaxant, a hypnotic, an analgesic painkiller, and an anti-inflammatory compound.

Limonene is a terpene prevalent in citrus as well as in cannabis, and has been used clinically to dissolve gallstones, improve mood and relieve heartburn and gastrointestinal reflux. Limonene has been shown to destroy breast-cancer cells in lab experiments, and its powerful antimicrobial action can kill pathogenic bacteria.

Linalool is a terpenoid prominent in lavender as well as in some cannabis strains. It is an anxiolytic compound that counters anxiety and mediates stress. In addition, linalool is a strong anticonvulsant, and it also amplifies serotonin-receptor transmission, conferring an antidepressant effect. Applied topically, linalool can heal acne and skin burns without scarring.

Beta-caryophyllene is a sesquiterpene found in the essential oils of black pepper, oregano and other edible herbs, as well as in cannabis and many green, leafy vegetables. It is gastro-protective, good for treating certain ulcers, and shows great promise as a therapeutic compound for inflammatory conditions and autoimmune disorders because of its ability to bind directly to the peripheral cannabinoid receptor known as CB2.

THC also activates the CB2 receptor, which regulates immune function and the peripheral nervous system. What causes the psychoactive effect brought on by consuming THC is that THC binds to the CB1 receptor, which is concentrated in the brain and the central nervous system.

Stimulating the CB2 receptor doesn't have a psychoactive effect because CB2 receptors are localized predominantly outside the brain and central nervous system. CB2 receptors are present in the gut, spleen, liver, heart, kidneys, bones, blood vessels, lymph cells, endocrine glands, and reproductive organs. Marijuana is such a versatile medicinal substance because it acts everywhere, not just in the brain.

There are over 400 chemical compounds in marijuana, including cannabinoids, terpenoids and flavonoids. Each has specific medicinal attributes, which combine to create an effect such that the therapeutic impact of the whole plant is greater than the sum of its parts. An example of this can be demonstrated with the use of Marinol, which is a pharmacological compound of pure THC. For recreational marijuana users who have tried both pure THC (in the form of a pure pharmacologically produced THC pill) and conventional cannabis flowers or concentrates consumed by smoking, eating, or vaporizing, most agree that the experience of THC alone compares poorly to that of THC combined with terpenes and other components of the cannabis plant. Cannabinoid/terpenoid interactions can amplify the beneficial effects of cannabis while reducing THC-induced anxiety. Ingesting pure THC in pill form would not enable these beneficial effects.

Certain terpenoids dilate capillaries in the lungs, enabling smoked or vaporized THC to enter the bloodstream more easily. Nerolidol, a sedative terpenoid, is a skin penetrant that increases permeability and potentially facilitates cannabinoid absorption when applied topically for pain or skin conditions. Terpenoids and cannabinoids both increase blood flow, enhance cortical activity and kill respiratory pathogens—including MSRA, the antibiotic-resistant bacteria that in recent years has claimed the lives of tens of thousands of people.

In 2011 the first successful lab emerged with the ability to test cannabis strains for terpenes. In the course of testing it was occasionally revealed that strains with different names had identical terpene content. Given the need for consistency in the case of medical marijuana, the unique “fingerprint” nature of cannabis terpenes can be used to make sure the marijuana is being provided in a consistent manner, i.e. if a patient has a specific condition that is ameliorated by a certain terpene/cannabinoid combination, it is generally desirable for that patient to get “medicine” that contains that ideal terpene/cannabinoid combination each time they renew their medical marijuana prescription. Terpene testing can aid in determining this type of beneficial consistency in the cannabis product. In addition to testing cannabis plant material for terpene content, the lab has also tested numerous cannabis extracts for their terpene content. However, the oil-extraction process, if it involves heating the plant matter, typically destroys the terpenes, which evaporate at much lower temperatures than THC. The extract maker may need to add the terpenes back into the oil concentrate in order to maximize the plant's therapeutic potential. A proper concentrate recipe can be used to access strain-specific cannabis oils, as well as made-to-order marijuana extracts with a full array of terpenes custom tailored to meet the needs and desires of individual users.

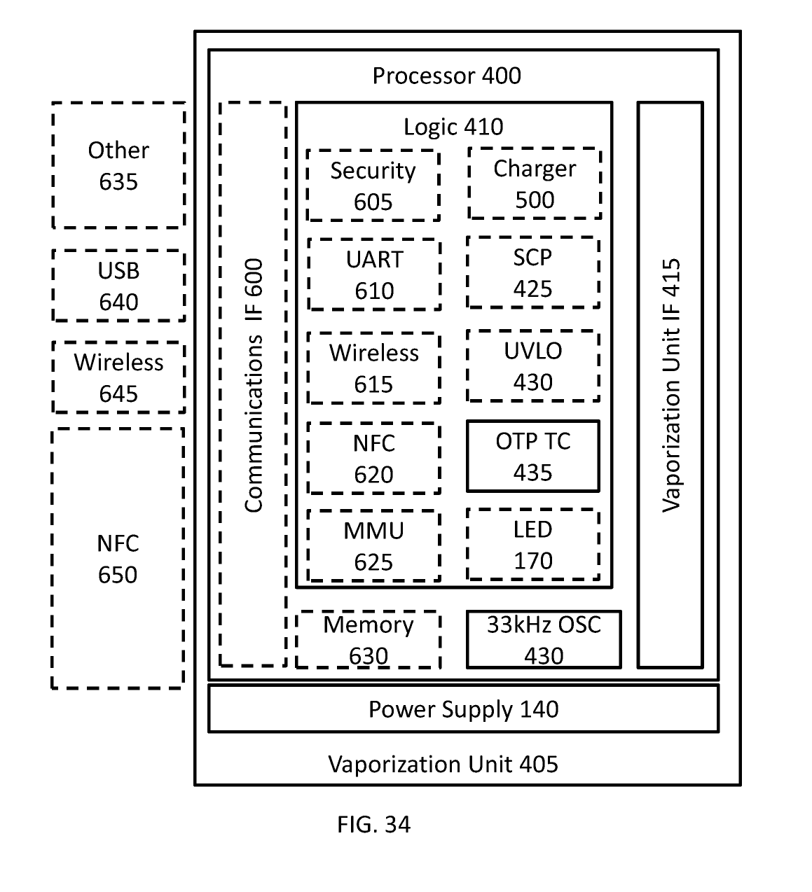

FIG. 34 depicts the processor 400 for OTP temperature control for selective removal of cannabinoid compounds and terpenes.

As a method for marking and identifying lab-produced cannabis concentrates or cultivated marijuana in plant form, artificial or natural terpenes may be added to the product after production. In an example of one embodiment, specific unique terpenes are added to lab-produced cannabis concentrate. The concentrate is named and labeled, and distributed through proper channels. If certain concentrate product finds its way into illegal possession or undesirable locations, and is later discovered by law enforcement, it can be tested for the specific artificial terpene to determine its origin. Future regulations can be put in place to require legal marijuana products to contain a particular terpene or combination of terpenes that are unique to each producer. Additionally, if the marijuana product distribution chain requires multiple brokers, distributors, or “middlemen”, then the unique terpene configuration can be added at each step of the distribution chain, with records kept for each terpene-addition step, until it reaches the end result consumer. In this way, if the marijuana product is misappropriated, law enforcement can review the terpene-addition records to determine where the product deviated from the proper distribution channel.

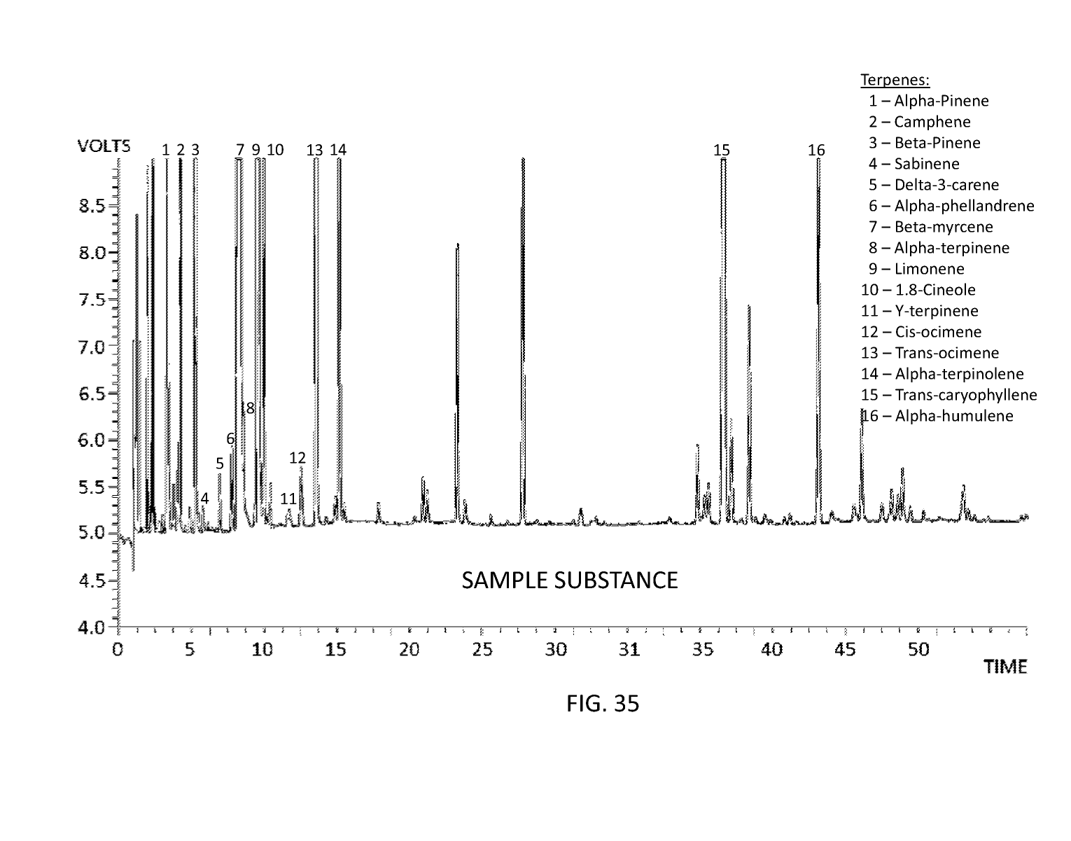

Terpenes consist of a large and diverse class of organic compounds which emit terpenes from the osmeteria. The structure can be derived biosynthetically from units of isoprene in a lab or they can occur naturally in the environment. The emitted terpenes can be measured and cataloged in a laboratory environment. Mass chromatograms are produced to represent the mass spectrometry data that is collected when testing for terpenes. FIG. 35 shows an example terpene mass chromatogram with mass retention time versus signal intensity. The variations in intensity over time indicate an example of the various terpene types that can be measured. With this data the terpenes in a substance can be identified and used for various purposes such as substance identification as described in additional embodiments of the present specification.

Another feature within the present embodiment is that any marijuana product that is discovered to not contain the specific set of terpenes as described in the specific terpene recipe would be known to be illicit or illegitimate, and not in compliance with certain regulatory standards. In other words, regulatory standards can be enacted requiring the use or non-use of certain fertilizers, pesticides, growing techniques, or general production methods. Additionally, recipes can be standardized and regulated for certain terpene configurations, cannabinoid combinations, potency standards, and other factors deemed beneficial to the user. In this embodiment, regulations are enacted to require certain standardized recipes to contain a unique “fingerprint” of added terpenes that is unique to the specific standardized recipe. As example, a cannabis concentrate or cannabis plant is produced containing a standardized blend of cannabinoids and terpenes (cannabis components) that is determined to be ideally suited for treating, say, nausea (or any medical condition with symptoms known to be alleviated by specific cannabis components). One of the final steps of production of the cannabis product is to add a unique and/or secret terpene or combination of terpenes that, when tested, shows up in the cannabis product test results. The presence of this unique or secret terpene or combination of terpenes assures that the product is what it claims to be, and that the product will medically do what the specific combination of cannabis components is known to do. If the cannabis product claims to be a certain type, and the recipe for that certain type is required to comply with a specific terpene configuration, and testing shows the absence of the specific terpene configuration, then it would be an indication that the claim of being the certain type is false. In the case of legal recreational cannabis products, if a cannabis product tests negative for the certain terpene configuration it would be known to be made illegally or with no adherence to growing standards for using proper fertilizers, pesticides, soil components, or growing standards in general. Moreover, cannabis products that test negative for the specific terpene configuration may have circumvented state and federal tax requirements. The presence of the specific terpene configuration can ensure that the cannabis product has moved through all the required regulatory steps in place at the time.

As further example, the inventors point to a scenario wherein a first unique marking terpene or terpenes [hereinafter “marking terpene(s)”] is added during lab production. A second unique marking terpene(s) is (are) added once it has arrived to the location of a first broker or warehouse. A third unique marking terpene(s) is (are) added at the next location of the distribution cycle, and so on until the cannabis product is provided to the end-result user. In the case of law enforcement personnel seizing misappropriated cannabis product, they can review the terpene marking recipe chain back to a step in the distribution cycle where a certain marking terpene(s) is (are) missing, thus aiding their investigation on determining at what stage the misappropriation occurred. In the case of law enforcement seizing cannabis product completely absent of the known unique marking terpene(s) recipe, it will be known to be produced with no regard for product safety regulations that are in place at the time. Furthermore, mechanisms or equipment for testing the presence of unique marking terpene(s) can be available to members of the public, such as a portable gas chromatography testing unit, thereby allowing the user to test for themselves the presence of the unique marking terpene(s), allowing them to know with certainty that the cannabis product adheres to the previously mentioned certain production standards of purity and potency.

In this way the terpene marking recipe will ensure for users, distributors, regulation enforcement authorities, manufacturers, and any entity involved in the cannabis distribution and use cycle the desired safety, consistency, purity, and effects of the cannabis product.

In another embodiment, non-radioactive isotopes are used in place of terpenes for purposes of marking and tracing the cannabis product.

In another embodiment, cannabis flowers or leaves, left in their naturally occurring form, i.e. not processed into cannabis concentrate, are sprayed or otherwise subjected to terpene(s) component, thereby allowing the same marking and tracing scenario as mentioned above.

A smart machine may be used to control filling for the substance containers used with the vaporizing unit. The smart machine may only be used by registered vendors to prevent dosage or drug tampering by users. A recipe book may be included to prevent vendors from misuse such as using substandard products. The smart machine may be connected to the Internet and/or smart devices where usage may be tracked and controlled. A system may be implemented wherein the substance container of the unit (in one embodiment the filled substance container contains cannabis concentrate) is only removable and/or fillable by a specific “smart” machine, and any attempt to vary from the required filling protocol renders the unit inoperable. In an example of this embodiment, the filling machine has a specific unique aperture that must match an aperture in the unit for filling to occur. If the apertures between the unit and the filling machine do not match, a trigger effect occurs causing a circuit to be broken in the device, rendering the electrical heating components inoperable.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or described features can be implemented by themselves, or in combination with other operations in either hardware or software.

Having described and illustrated the principles of the invention in a preferred embodiment thereof, it should be apparent that the invention may be modified in arrangement and detail without departing from such principles. Claim is made to all modifications and variation coming within the spirit and scope of the disclosure.

1. A vaporization device, comprising:
a housing;
a mouthpiece attached to a first end of the housing;
a container located in the housing next to the mouthpiece for retaining a consumable substance;
a heating device located within the container configured to vaporize the consumable substance;
a battery located next to the container for actuating the heating device; and
a wick coupled between the container and the heating device configured to draw the consumable substance from the container to the heating device.

2. The vaporization device of claim 1, wherein the wick is further configured to draw the consumable substance from the container via a capillary action.

3. The vaporization device of claim 1, wherein the heating device comprises a wire heating coil, wherein the wire heating coil is wrapped around the wick.

4. The vaporization device of claim 1, wherein the wick is configured to provide a substantially constant rate of consumable substance flowing to the heating device.

5. The vaporization device of claim 1, wherein the wick comprises a substantially round outside circumference and is configured to transversely seat into the housing between the consumable substance in the container and the heating device.

6. The vaporization device of claim 1, wherein the wick comprises a ceramic fiber material.

7. The vaporization device of claim 1, further comprising a filter located between the wick and the consumable substance in the container.

8. The vaporization device of claim 7, further wherein the filter has a substantially round outside circumference and is configured to transversely seat into the housing between the consumable substance in the container and the wick.

9. The vaporization device of claim 7, wherein the filter comprises a screen of transversely interconnected non-organic members.

10. A vaporization unit, comprising:
an external housing retaining a substance container, a filter, a vaporization chamber, and a heating circuit;
a memory retaining a unique identifier; and
a first processor configured to communicate the unique identifier to a second processor, wherein the second processor is located in at least one of a smart device and a filling machine.

11. The vaporization unit of claim 10, further comprising a pressure sensor configured to activate the heating circuit.

12. The vaporization unit of claim 11, wherein the pressure sensor is further configured to activate at least one of a biometric scanner, a GPS mechanism, and a clock retained within the external housing.

13. The vaporization unit of claim 10, wherein the first processor is further configured to monitor consumption data and store the consumption data in a first memory.

14. The vaporization unit of claim 13, wherein the first processor is configured to send a copy of the data, including but not limited to consumption data, to a second processor to be stored in a second memory, wherein the second processor sends a copy of the consumption data to a third processor to be stored in a third memory, wherein the data in memory associated with the third processor may be accessed and modified, and wherein the modified data is stored in the third memory, and wherein the third processor sends a copy of the stored data to the second processor to be stored in the second memory, wherein the second processor sends a copy of the stored data to the first processor to be stored in the first memory, and wherein the first processor uses the stored data to control future consumption.

15. The vaporization unit of claim 10, wherein the processor is further configured to enable the vaporization unit in response to a unique user ID (UUID), biometric input, or usage data received from the second processor.

16. The vaporization unit of claim 10, wherein the first processor is further configured to control a flow rate of material from the substance container to the vaporization chamber by controlling the heating circuit to limit at least one of the length of time that the heating element is activated and the number of heating cycles per dose session.

17. The vaporization unit of claim 10, further comprising a wick attached to the heating circuit, wherein the wick through a capillary action is configured to draw the consumable substance from the substance container to the heating circuit.
